(19) United States
(12) Patent Application Publication
(10) Pub. No.: US 2006/0262330 A1
(43) Pub. Date: Nov. 23, 2006

(54) Image processing method, correction-value acquiring method, and printing method

(75) Inventor: Takashi Koase, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 11/412,994

(22) Filed: Apr. 28, 2006

(30) Foreign Application Priority Data
Apr. 28, 2005 (JP) 2005-133708

(51) Int. Cl. G06K 15/02

(52) U.S. Cl. 358/1.2

(57) ABSTRACT

An image processing method, includes: a first reading step of reading, as image data, a scale with a scanner; a second reading step of reading, as image data, a document with the scanner; and a correction step of correcting the image data of the document using the image data of the scale.

### CROSS-REFERENCE TO RELATED APPLICATIONS

The present application claims priority upon Japanese Patent Application No. 2005-133708 filed on Apr. 28, 2005, which is herein incorporated by reference.

### BACKGROUND

1. Technical Field

The present invention relates to image processing methods, correction-value acquiring methods, and printing methods.

2. Related Art

There are known printing apparatuses for printing print images on media (such as paper, cloth, and OHP film) by repeating in alternation the following operations: a dot formation operation in which dots are formed on a medium by ejecting ink from a head moving in a movement direction and a carrying operation in which the medium is carried. A print image printed with such printing apparatuses is made up of numerous image fragments, each consisting of a row of dots, lined up in the carrying direction.

The dot row which each image fragment consists of is formed by making an ink droplet ejected from a nozzle of the head land on the medium. If an ink droplet of ideal size lands in an ideal position, each dot row will be formed in its corresponding predetermined region (row region), and an image fragment with ideal darkness will be formed in that region. However, in practice, because of influence due to variation in manufacturing precision and the like, variation in darkness occurs among the image fragments formed in the respective regions. As a result thereof, a streaky unevenness in darkness occurs in the print image.

Technologies for suppressing this unevenness in darkness and improving print image quality have been proposed (see JP-A-2-54676 and JP-A-6-166247, for example).

An image processing unit disclosed in JP-A-2-54676 performs sampling of an image with a CCD sensor and outputs the digitized data through an inkjet printer. In order to correct unevenness in darkness, the image processing unit disclosed in JP-A-2-54676 stores, as coefficients, characteristics of variation in gain of the CCD sensor and characteristics of unevenness in darkness of a head, and performs binarization taking these coefficients into account.

In a method of correcting unevenness in recorded darkness disclosed in JP-A-6-166247, patterns for detecting unevenness in darkness are printed and unevenness in darkness is corrected based on darkness data of the patterns for detecting unevenness in darkness.

JP-A-2-54676 does not disclose how to obtain the coefficients reflecting the characteristics of variation in gain of the CCD sensor. Accordingly, depending on the method for obtaining these coefficients, there are cases in which these coefficients will not reflect the characteristics of the CCD sensor properly. If these coefficients do not reflect the characteristics of the CCD sensor properly, then unevenness in darkness will occur in a print image.

In JP-A-6-166247, after the patterns for detecting unevenness in darkness are printed, the patterns for detecting unevenness in darkness are read with an image sensor, and darkness data is created. However, if an image sensor cannot read the patterns for detecting unevenness in darkness properly, the unevenness in darkness cannot be corrected properly and a printed image will exhibit variations in darkness.

As mentioned above, a print image will deteriorate in quality if a scanner for reading an image cannot read a document properly. Further, not only are there demands for printing an image properly, there also are demands for properly reading an image without suffering effects of the characteristics of the scanner when reading an image from a document with a scanner.

### SUMMARY

An advantage achieved by some aspects of the present invention is that it is possible to correct image data such that an image expressed by image data of a document that has been read with a scanner becomes similar to the image on the document.

A primary aspect of the invention is an image processing method, including: a first reading step of reading, as image data, a scale with a scanner; a second reading step of reading, as image data, a document with the scanner; and a correction step of correcting the image data of the document using the image data of the scale.

Other features of the present invention will be made clear through the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein;

FIG. 1 is a diagram for describing the configuration of a printing system 100;

FIG. 2 is a block diagram that shows the overall configuration of a printer 1;

FIG. 3A is a schematic diagram showing the overall structure of the printer 1, and FIG. 3B is a horizontal sectional view of the overall structure of the printer 1;

FIG. 4 is an explanatory diagram showing the arrangement of nozzles in the lower surface of a head 41;

FIG. 5A is a vertical sectional view of a scanner 150, and FIG. 5B is a plan view of the scanner 150 with its lid 151 detached;

FIG. 6 is a flowchart of processing during printing;

FIGS. 7A and 7B are explanatory diagrams of regular printing, where FIG. 7A shows positions of the head and how dots are formed in each of the pass n through pass n+3, and FIG. 7B shows positions of the head and how dots are formed in each of the pass n through pass n+4;

FIG. 8 is an explanatory diagram for describing front-end printing and rear-end printing;

FIG. 9A is an explanatory diagram showing a state in which dots are formed ideally, FIG. 9B is an explanatory diagram showing how the variation in manufacturing precision among nozzles affects dot formation, and FIG. 9C is an explanatory diagram showing how dots are formed by the printing method of the present embodiment;

FIG. 10 is a flowchart of correction-value acquisition processing carried out during an inspection step after the printer has been manufactured;

FIG. 11 is an explanatory diagram showing a test pattern;

FIG. 12 is an explanatory diagram showing a correction pattern;

FIG. 13 is a diagram for describing a reading range for a cyan correction pattern;

FIG. 14A is an explanatory diagram showing image data at the time of detecting an inclination, FIG. 14B is a diagram for describing how the position of a top ruled line is detected, and FIG. 14C is an explanatory diagram showing image data after the rotation processing;

FIG. 15A is an explanatory diagram showing image data at the time of trimming, FIG. 15B is a diagram for describing the trimming position at the top ruled line, and FIG. 15C is a diagram for describing the trimming position at the bottom ruled line;

FIG. 16 is a diagram for describing resolution conversion;

FIG. 17A is an explanatory diagram showing image data at the time of detecting the left ruled line, FIG. 17B is a diagram for describing how the position of the left ruled line is detected, and FIG. 17C is a diagram for describing a measurement range for measuring the darkness in the first row region of a belt-like pattern having a darkness of 30%;

FIG. 18 is a measurement value table in which the results of measuring the darkness of five types of belt-like patterns for cyan are summarized;

FIG. 19 is a graph showing the measurement values of the cyan belt-like patterns having 30% darkness, 40% darkness, and 50% darkness, respectively;

FIG. 20A is a diagram for describing a target designated tone value Sbt for the designated tone value Sb in the row region i, and FIG. 20B is a diagram for describing a target designated tone value Sbt for the designated tone value Sb in the row region j;

FIG. 21 is an explanatory diagram showing correction value tables for cyan;

FIG. 22 is a flowchart showing processing performed under instructions by a user;

FIG. 23 is a flowchart of print-data generation processing;

FIG. 24 is an explanatory diagram showing darkness correction processing for an n-th row region for cyan;

FIG. 25 is a graph showing an error in the reading position of the scanner;

FIG. 26A is an explanatory diagram showing a relationship between a document and image data when the reading position of the scanner is correct, FIG. 26B is an explanatory diagram showing a relationship between a document and image data when there is an error in the reading position of the scanner, and FIG. 26C is an explanatory diagram showing image data before and after correction;

FIG. 27 is a flowchart of pre-processing;

FIG. 28 is an explanatory diagram showing how a linear scale 7 is placed on a document platen glass 152 of the scanner 150;

FIG. 29 is a graph showing one-dimensional image data of the linear scale;

FIG. 30A is an explanatory diagram showing pixel data of the sixteen pixels that have been taken out, and FIG. 30B is an explanatory diagram showing normalized pixel data;

FIG. 31 is an explanatory diagram showing the next calculation range;

FIG. 32 is an explanatory diagram describing how to calculate darkness calculation positions;

FIG. 33 is a flowchart of post-processing; and

FIG. 34 is an explanatory diagram showing how the image data is corrected.

### DESCRIPTION OF EXEMPLARY EMBODIMENTS

At least the following matters will be made clear by the explanation in the present specification and the description of the accompanying drawings.

An image processing method, includes:

a first reading step of reading, as image data, a scale with a scanner;

a second reading step of reading, as image data, a document with the scanner; and

a correction step of correcting the image data of the document using the image data of the scale.

With this image processing method, it is possible to make the image expressed by the image data become similar to the image of the document, even when there is a reading error in the scanner.

It is preferable that the image processing method further includes a step of detecting a position of a graduation marking on the scale based on the image data of the scale; and in the correction step, the image data of the document is corrected based on the position of the graduation marking on the scale. In this way, it is possible to correct the image data based on the actual position of the graduation marking, even when the image expressed by the image data that has been read is deformed. Further, it is preferable that in the correction step, the image data of the document is corrected by calculating, based on the image data of the document, pixel data corresponding to the position of the graduation marking among a plurality of pieces of pixel data that make up the corrected image data. In this way, it is possible to acquire image data in which the position in the document corresponds to the position of the graduation marking. Further, it is preferable that in the correction step, the pixel data corresponding to the position of the graduation marking among the plurality of pieces of the pixel data that make up the corrected image data is calculated based on the image data of the document, by performing linear interpolation with respect to pixel data that make up the image data of the document. This is because it is rare that the image data includes data corresponding to the position of the graduation marking.

It is preferable that the image processing method further includes a step of obtaining a position at a shorter interval than an interval of the graduation marking based on the position of the graduation marking on the scale; and in the correction step, the image data of the document is corrected based on the position at the shorter interval. In this way, it is possible to increase the resolution of the corrected image data. Further, it is preferable that the position at the shorter interval is obtained through linear interpolation based on the position of the graduation marking on the scale.

Further, it is preferable that, in the foregoing image processing method, the scanner has a reading carriage that moves in order to make a sensor for reading an image move; and in the first reading step, the scale that is set in a direction in which the reading carriage moves is read. In this way, it is possible to make the image expressed by the image data become similar to the image of the document, even when there is an error in the reading position of the scanner.

Further, it is preferable that, in the foregoing image processing method, the document has a pattern formed thereon, the pattern being made up of a plurality of dot rows, each dot row being formed in a row region by ejection of ink from at least one of a plurality of nozzles that move in a movement direction, each row region being arranged in the movement direction of the nozzles, the plurality of dot rows that make up the pattern being respectively formed in a plurality of the row regions that are lined up in a direction intersecting the movement direction; and a darkness of each of the row regions is measured using image data of the pattern, which is the image data of the document, that has been corrected in the correction step. In this way, it is possible to measure the darkness of the row regions properly.

Further, a correction-value acquiring method, includes:

reading, as image data, a scale with a scanner;

printing a pattern using a printing apparatus;

reading, as image data, the pattern with the scanner;

correcting the image data of the pattern using the image data of the scale; and

acquiring a correction value that suits the printing apparatus by using the image data of the pattern that has been corrected.

With this correction-value acquiring method, it is possible to acquire correction values that suit each printing apparatus.

Further, a method for manufacturing a printing apparatus, includes:

reading, as image data, a scale with a scanner;

printing a pattern using a printing apparatus;

reading, as image data, the pattern with the scanner;

correcting the image data of the pattern using the image data of the scale;

acquiring a correction value that suits the printing apparatus by using the image data of the pattern that has been corrected; and

storing the correction value in a memory of the printing apparatus.

With this printing-apparatus manufacturing method, it is possible to manufacture a printing apparatus storing suitable correction values in its memory.

Further, a printing method, includes:

reading, as image data, a scale with a scanner;

printing a pattern using a printing apparatus;

reading, as image data, the pattern with the scanner;

correcting the image data of the pattern using the image data of the scale; and

printing with the printing apparatus, while correcting, by using the image data of the pattern that has been corrected, the printing that is carried out by the printing apparatus.

With this printing method, it is possible to print a print image with high quality.

===Configuration of Printing System===

<Printing System>

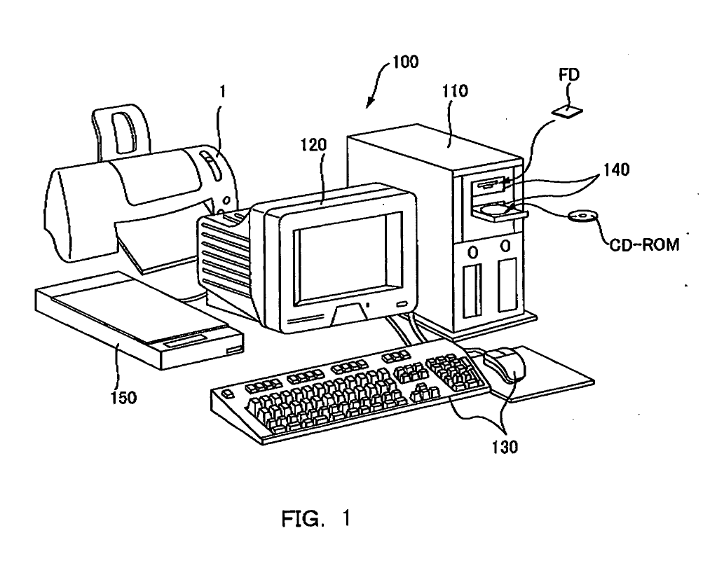

FIG. 1 is a diagram for describing the configuration of a printing system 100. The printing system consists of at least a printing apparatus and a print-control apparatus that controls operations of the printing apparatus. The printing system 100 of the present embodiment is provided with a printer 1, a computer 110, a display device 120, input devices 130, record/play devices 140, and a scanner 150.

The printer 1 is for printing images on a medium such as paper, cloth, film, and OHP film. The computer 110 is communicably connected to the printer 1. In order to make the printer 1 print an image, the computer 110 outputs print data corresponding to that image to the printer 1. This computer 110 has computer programs, such as an application program and a printer driver, installed thereon. A scanner driver is also installed on the computer 110 and is for controlling the scanner 150 and for receiving image data of a document read by the scanner 150.

<Printer>

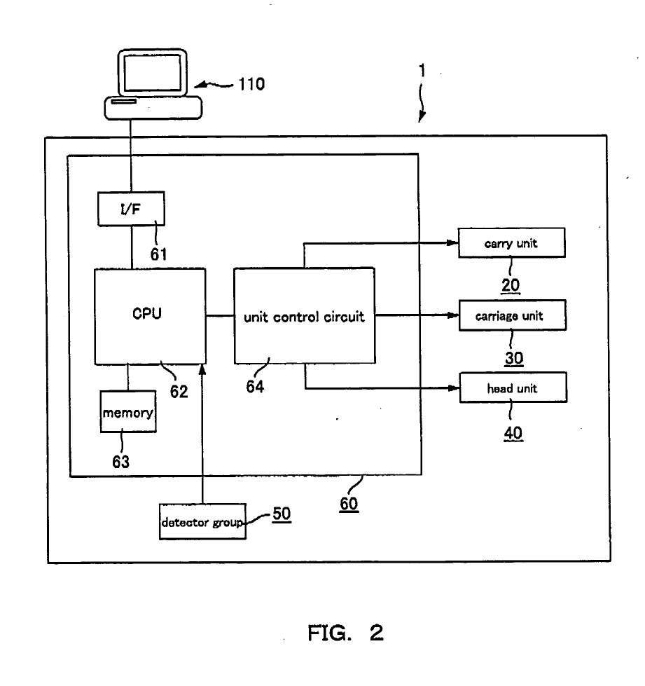

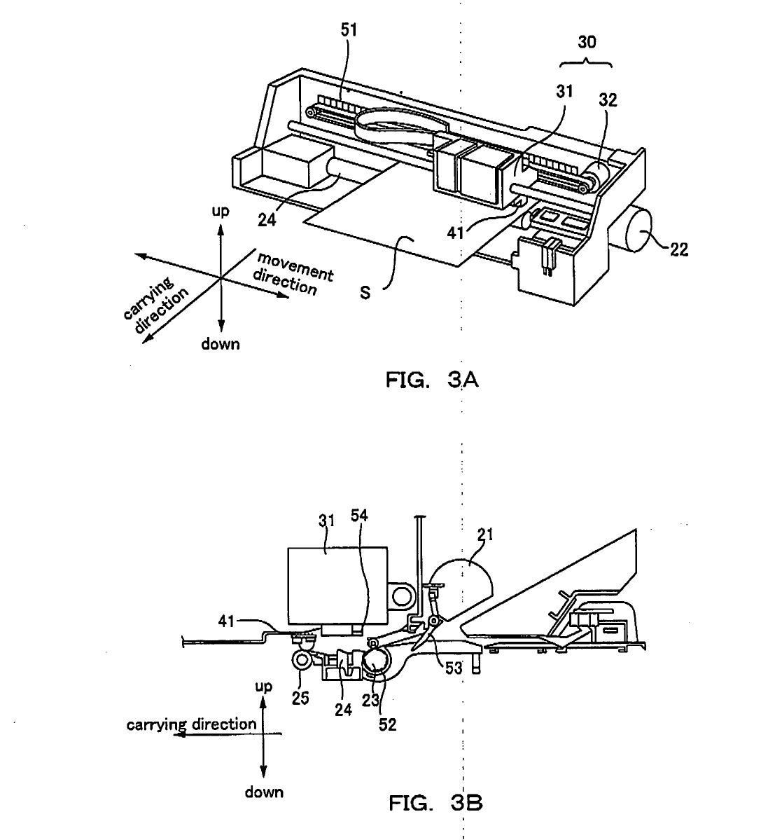

FIG. 2 is a block diagram that shows the overall configuration of the printer 1. FIG. 3A is a schematic diagram showing the overall structure of the printer 1. FIG. 3B is a horizontal sectional view of the overall structure of the printer 1. The basic structure of the printer according to the present embodiment is described below.

The printer 1 has a carry unit 20, a carriage unit 30, a head unit 40, a detector group 50, and a controller 60. The printer 1 receives print data from the computer 110, which is an external device, and controls the various units (the carry unit 20, the carriage unit 30, and the head unit 40) through the controller 60. The controller 60 controls these units based on the print data received from the computer 110 to print an image on the paper. The detector group 50 monitors the conditions within the printer 1, and outputs the result of this detection to the controller 60. The controller 60 controls these units based on this detection result received from the detector group 50.

The carry unit 20 is for carrying a medium such as paper in a predetermined direction hereinafter, referred to as the carrying direction). The carry unit 20 has a paper supply roller 21, a carry motor 22 (also referred to as “PF motor”), a carry roller 23, a platen 24, and a paper discharge roller 25. The paper supply roller 21 is a roller for supplying, into the printer, paper that has been inserted into a paper insert opening. The carry roller 23 is a roller for carrying a paper S that has been supplied by the paper supply roller 21 up to a printable region, and is driven by the carry motor 22. The platen 24 supports the paper S being printed. The paper discharge roller 25 is a roller for discharging the paper S outside the printer, and is provided on the downstream side in the carrying direction with respect to the printable region. The paper discharge roller 25 is rotated in synchronization with the carry roller 23.

The carriage unit 30 is for making a head move (also referred to as “scan”) in a predetermined direction (hereinafter, referred to as the movement direction). The carriage unit 30 has a carriage 31 and a carriage motor 32 (also referred to as “CR motor”). The carriage 31 can be moved back and forth in the movement direction. The carriage 31 detachably holds ink cartridges that contain ink. The carriage motor 32 is a motor for moving the carriage 31 in the movement direction.

The head unit 40 is for ejecting ink onto the paper. The head unit 40 has a head 41. The head 41 has a plurality of nozzles and intermittently ejects ink from those nozzles. The head 41 is provided in the carriage 31. Thus, when the carriage 31 moves in the movement direction, the head 41 also moves in the movement direction. Dot rows (raster lines) are formed on the paper in the movement direction due to the head 41 intermittently ejecting ink while moving in the movement direction.

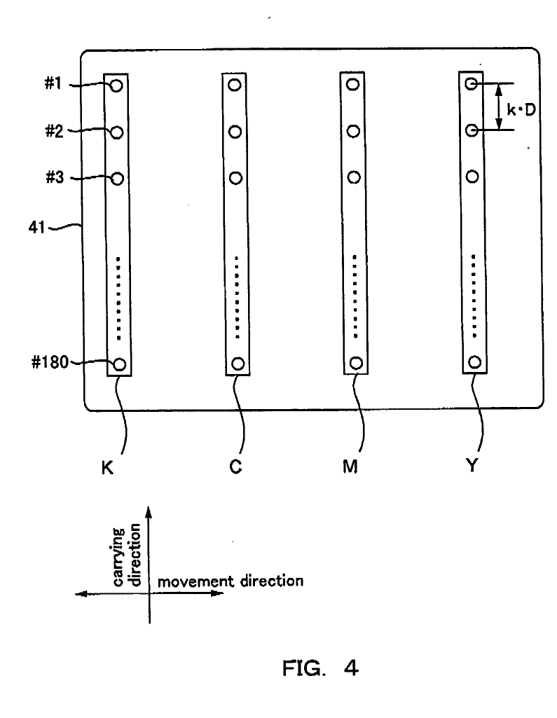

FIG. 4 is an explanatory diagram showing the arrangement of the nozzles in the lower surface of the head 41. A black ink nozzle group K, a cyan ink nozzle group C, a magenta ink nozzle group M, and a yellow ink nozzle group Y are formed in the lower surface of the head 41. Each nozzle group is provided with a plurality of nozzles, which are ejection openings for ejecting ink of the respective colors. The plurality of nozzles of each of the nozzle groups are arranged in rows at a constant spacing (nozzle pitch: k·D) in the carrying direction. Here, D is the minimum dot pitch in the carrying direction (that is, the spacing between dots formed on the paper S at maximum resolution). Further, k is an integer of 1 or more. For example, if the nozzle pitch is 180 dpi ( 1/180 inch), and the dot pitch in the carrying direction is 720 dpi ( 1/720 inch), then k=4. Each nozzle of each of the nozzle groups is assigned a number (#1 to #180) that becomes smaller as the nozzle is arranged more downstream. Each nozzle is provided with an ink chamber (not shown) and a piezo element. Driving the piezo element causes the ink chamber to expand and contract, thereby ejecting an ink droplet from the nozzle.

The detector group 50 includes a linear encoder 51, a rotary encoder 52, a paper detection sensor 53, an optical sensor 54, and the like. The linear encoder 51 is for detecting the position of the carriage 31 in the movement direction. The rotary encoder 52 is for detecting the amount of rotation of the carry roller 23. The paper detection sensor 53 is for detecting the position of the front end of the paper to be printed. The optical sensor 54 is attached to the carriage 31. The optical sensor 54 detects whether or not the paper is present, through its light-receiving section detecting the reflected light of the light that has been irradiated onto the paper from its light-emitting section.

The controller 60 is a control section for carrying out control of the printer. The controller 60 includes an interface section 61, a CPU 62, a memory 63, and a unit control circuit 64. The interface section 61 is for exchanging data between the computer 110, which is an external device, and the printer 1. The CPU 62 is a processing unit for carrying out overall control of the printer. The memory 63 is for ensuring a working area and a storage area for the programs for the CPU 62, for instance, and includes storage devices such as a RAM or an EEPROM. The CPU 62 controls the various units via the unit control circuit 64 in accordance with programs stored in the memory 63.

<Scanner>

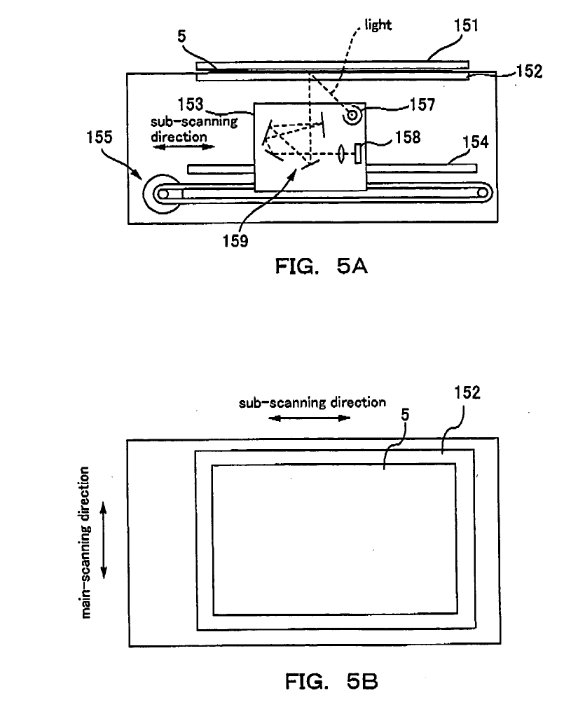

FIG. 5A is a vertical sectional view of the scanner 150. FIG. 5B is a plan view of the scanner 150 with its lid 151 detached.

The scanner 150 is provided with the lid 151, a document platen glass 152 on which a document 5 is placed, a reading carriage 153 that faces the document 5 through the document platen glass 152 and that moves in a sub-scanning direction, a guiding member 154 for guiding the reading carriage 153 in the sub-scanning direction, a moving mechanism 155 for moving the reading carriage 153, and a scanner controller (not shown) that controls the various units of the scanner 150. The reading carriage 153 has an exposure lamp 157 that shines light on the document 5, a line sensor 158 that detects a line image in a main scanning direction (in FIG. 5A, the direction normal to the surface of the paper on which the figure is described), and optical devices 159 that lead the reflected light from the document 5 to the line sensor 158. Dashed lines in the reading carriage 153 shown in FIG. 5A show the path of light.

In order to read an image of the document 5, an operator raises the lid 151, places the document 5 on the document platen glass 152, and lowers the lid 151. The scanner controller moves the reading carriage 153 in the sub-scanning direction with the exposure lamp 157 emitting light, and the line sensor 158 reads the image on a surface of the document 5. The scanner controller transmits the read image data to the scanner driver installed on the computer 110, and thereby, the computer 110 obtains the image data of the document 5.

===Printing Method===

<Regarding Printing operation>

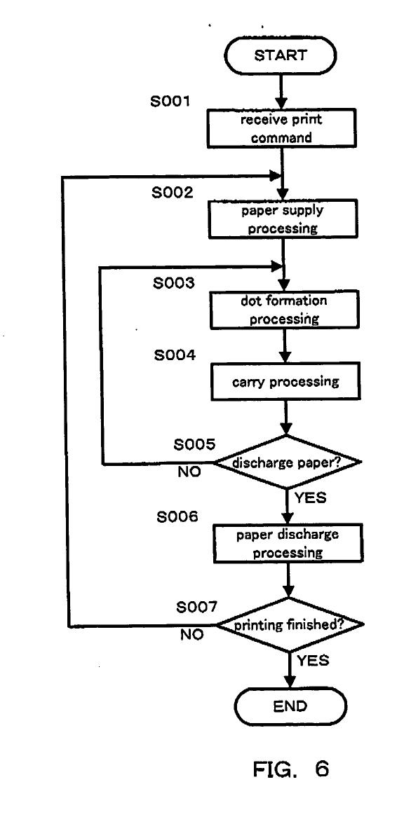

FIG. 6 is a flowchart of the processing during printing. The processes described below are executed by the controller 60 controlling the various units in accordance with a program stored in the memory 63. This program includes codes for executing the various processes.

Receipt of Print Command (S001): The controller 60 receives a print command via the interface section 61 from the computer 110. This print command is included in a header of print data transmitted from the computer 110. The controller 60 then analyzes the content of the various commands included in the print data received, and performs the following processes such as paper supply processing, carry processing, and dot formation processing by using the various units.

Paper Supply Processing (S002): The paper supply processing is a process for supplying paper to be printed into the printer and positioning the paper at a print start position (also referred to as “indexed position”). The controller 60 positions the paper at the print start position by rotating the paper supply roller 21 and the carry roller 23.

Dot Formation Processing (S003): The dot formation processing is a process for forming dots on the paper by ejecting ink intermittently from the head 41 that moves in the movement direction. The controller 60 moves the carriage 31 in the movement direction by driving the carriage motor 32, and then, while the carriage 31 is moving, causes the head 41 to eject ink in accordance with pixel data contained in the print data. Dots are formed on the paper when ink droplets ejected from the head 41 land on the paper. Since ink is intermittently ejected from the head 41 that is moving, dot rows (raster lines) consisting of a plurality of dots in the movement direction are formed on the paper.

Carry Processing (S004); The carry processing is a process for moving the paper relative to the head in the carrying direction. The controller 60 carries the paper in the carrying direction by rotating the carry roller 23. Due to this carry processing, the head 41 can form dots at positions that are different from the positions of the dots formed in the preceding dot formation processing, in the next dot formation processing.

Paper Discharge Determination (S005): The controller 60 determines whether or not to discharge the paper being printed. The paper is not discharged if there remains data to be printed on the paper being printed. The controller 60 gradually prints an image consisting of dots on the paper by alternately repeating the dot formation processing and carry processing until there is no more data to be printed.

Paper Discharge Processing (S006): When there is no more data to be printed on the paper being printed, the controller 60 discharges the paper by rotating the paper discharge roller. It should be noted that whether or not to discharge the paper can also be determined based on a paper discharge command included in the print data.

Print Ending Determination (S007): Next, the controller 60 determines whether or not to continue printing. If a next sheet of paper is to be printed, then printing is continued and the paper supply processing for the next paper starts. If the next sheet of paper is not to be printed, then the printing operation is terminated.

<Regarding Formation of Raster Lines>

First, regular printing is described. The regular printing of the present embodiment is carried out using a printing mode referred to as interlaced printing. Here, “interlaced printing” means a printing scheme in which raster lines that are not recorded are sandwiched between raster lines that are recorded in one pass. A “pass” refers to one dot formation processing, and “pass n” refers to the n-th dot formation processing. A “raster line” refers to a row of dots lined up in the movement direction and is also referred to as “dot line”.

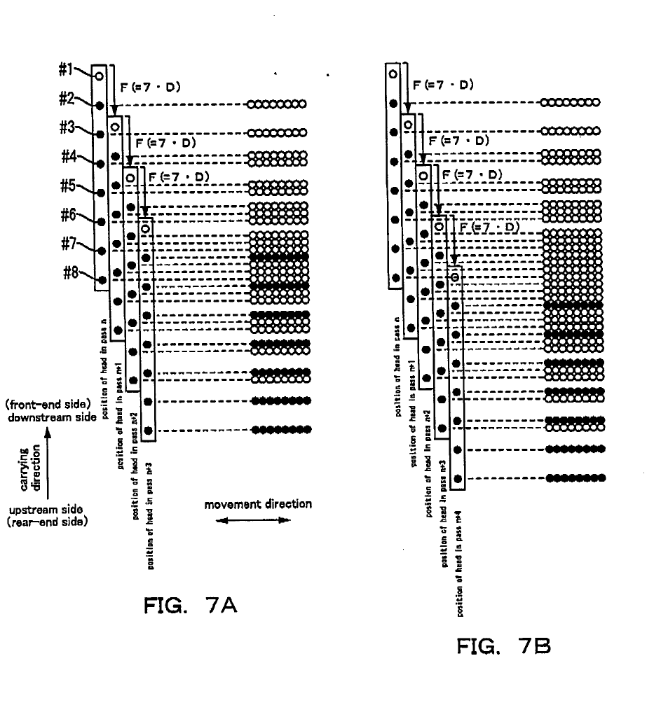

FIGS. 7A and 7B are explanatory diagrams of regular printing. FIG. 7A shows positions of the head and how dots are formed in each of the pass n through pass n+3, and FIG. 7B shows positions of the head and how dots are formed in each of the pass n through pass n+4.

It should be noted that, for convenience's sake, only one of a plurality of the nozzle groups is shown and the number of nozzles of each nozzle group is reduced. In addition, the head 41 (and the nozzle groups) is illustrated as if it is moving with respect to the paper, but the figures merely show the relative positional relationship between the head 41 and the paper, and in reality, the paper moves in the carrying direction. Furthermore, for convenience of explanation, each nozzle is illustrated as if it forms only a few dots (circles in the figure), but in reality, there are numerous dots lined up in the movement direction (this row of dots is the raster line) because ink droplets are intermittently ejected from the nozzles that move in the movement direction. As a matter of course, there are cases in which a dot is not formed depending on the pixel data.

In the figure, a nozzle shown with a filled circle is a nozzle that is allowed to eject ink and a nozzle shown with a white circle is a nozzle that is not allowed to eject ink. Furthermore, in the figure, a dot shown with a filled circle is a dot that is formed in the last pass and a dot shown with a white circle is a dot that is formed in other passes therebefore.

In this interlaced printing, every time the paper is carried in the carrying direction by a constant carry amount F, each nozzle records a raster line immediately above another raster line that was recorded in the immediately prior pass. In order to carry out recording with a constant carry amount in this way, it is required (1) that the number N (integer) of nozzles that are allowed to eject ink is coprime to k and (2) that the carry amount F is set to N·D. Here, N=7, k=4, and F=7·D (D= 1/720 inch).

However, there is a region in which raster lines cannot be formed continuously in the carrying direction in case of using only this regular printing. Therefore, printing modes which are respectively referred to as front-end printing and rear-end printing are carried out respectively before or after the regular printing.

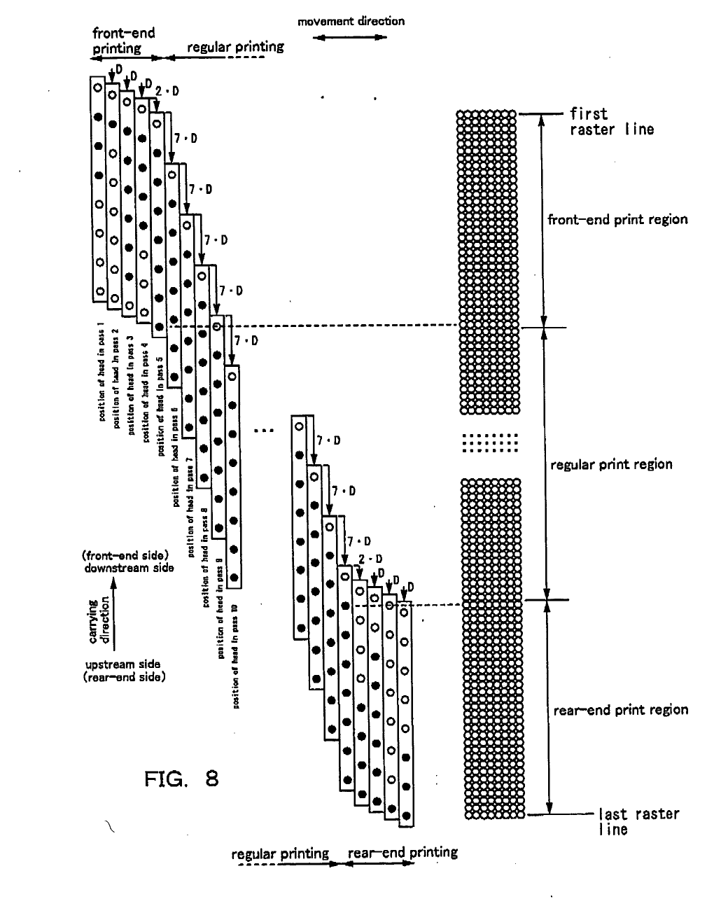

FIG. 8 is an explanatory diagram for describing front-end printing and rear-end printing. The first five passes correspond to the front-end printing, and the last five passes correspond to the rear-end printing.

In the front-end printing, at the time when a part near the front end of the print image is printed, the paper is carried by a smaller carry amount (1·D or 2·D) than the carry amount in the regular printing (7·D). Also, in the front-end printing, the nozzles that eject ink are not fixed. In the rear-end printing, in the same way as the front-end printing, at the time when a part near the rear end of the print image is printed, the paper is carried by a smaller carry amount (1·D or 2·D) than the carry amount in the regular printing (7·D). Also, in the rear-end printing, in the same way as the front-end printing, the nozzles that eject ink are not fixed. In this way, a plurality of raster lines lined up continuously in the carrying direction can be formed between the first raster line and the last raster line.

A region in which raster lines are formed solely by the regular printing is referred to as a “regular print region”. A region which is located on the front-end side of the paper (the downstream side in the carrying direction) with respect to the regular print region is referred to as a “front-end print region”. A region which is located on the rear-end side of the paper (the upstream side in the carrying direction) with respect to the regular print region is referred to as a “rear-endprintregion”. In the front-end print region, thirty raster lines are formed. Also, in the rear-end print region, thirty raster lines are formed. In the regular print region, thousands of raster lines are formed, depending on the size of the paper.

In the regular print region, there is regularity, for each set of raster lines of a number corresponding to the carry amount (seven in this example), in how the raster lines are arranged. The raster lines from the first one through the seventh one located in the regular print region shown in FIG. 8 are formed respectively by nozzle #3, nozzle #5, nozzle #7, nozzle #2, nozzle #4, nozzle #6, and nozzle #8, and the seven raster lines following the seventh raster line are formed respectively by the nozzles in the same order as mentioned above. On the other hand, in the front-end print region and rear-end print region, there is no simple regularity in how the raster lines are arranged in comparison with the raster lines in the regular print region.

===Outline of Correction for Unevenness in Darkness===

<Regarding Unevenness in Darkness (Banding)>

In this section, for convenience of explanation, a cause of unevenness in darkness that occurs in an image printed with monochrome printing is described. In case of multi-color printing, the cause of unevenness in darkness described below occurs for each color.

In the explanation below, a “unit region” means a virtual rectangular region determined on a medium such as paper, the size and shape of which are determined depending on print resolution. For example, in case that the print resolution is specified as 720 dpi (in the movement direction)×720 dpi (in the carrying direction), a unit region is a square region approximately 35.28 μm long and 35.28 μm wide (≈ 1/720 inch× 1/720 inch). In case that the print resolution is specified as 360 dpi×720 dpi, a unit region is a rectangular region approximately 70.56 μm long and 35.28 μm wide (≈ 1/360 inch× 1/720 inch). If an ink droplet is ideally ejected, the ink droplet lands in the center of this unit region, then the ink droplet spreads on the medium, and a dot is formed in the unit region. One unit region corresponds to one of pixels which image data consists of. Since each unit region corresponds to each pixel, pixel data of each pixel also corresponds to each unit region.

Furthermore, in the explanation below, a “row region” means a region consisting of a plurality of unit regions lined up in the movement direction. For example, in case that the print resolution is specified as 720 dpi×720 dpi, a row region is a belt-like region having a width of 35.28 μm (≈ 1/720 inch) in the carrying direction. If ink droplets are ideally ejected intermittently from a nozzle moving in the movement direction, a raster line is formed in this row region. One row region corresponds to a plurality of pixels lined up in the movement direction.

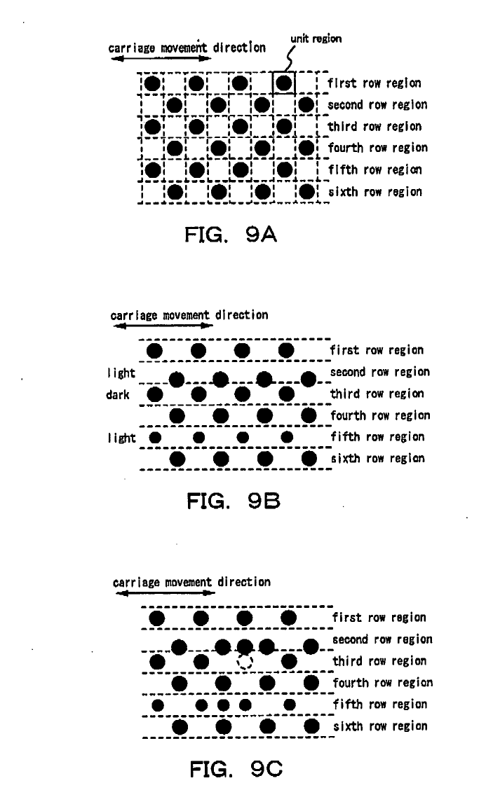

FIG. 9A is an explanatory diagram showing a state in which dots are formed ideally. In the figure, since dots are formed ideally, each dot is formed precisely in the unit region and each raster line is formed precisely in the row region. Each row region is illustrated in the figure as a region sandwiched by dotted lines, and in this case, is a region 1/720 inch in width. In each row region, an image fragment which has a darkness equivalent to the coloring of the region is formed. Here, for convenience of explanation, an image which has such a constant darkness that the dot-generation rate becomes 50% is printed.

FIG. 9B is an explanatory diagram showing how the variation in precision of manufacturing among nozzles affects dot formation. Here, the raster line formed in the second row region is formed closer to the side of the third row region (the upstream side in the carrying direction) because of variations in the flying direction of ink droplets ejected from nozzles. Also, since the amount of ink of ink droplets ejected to the fifth row region is small, dots formed in the fifth row region are smaller in size.

Despite that, by definition, image fragments having the same darkness should be formed in each row region, a variation in darkness occurs among image fragments depending on the row regions in which they are formed because of the variation in precision of manufacturing. For example, the image fragment in the second row region is formed relatively light in color, and the image fragment in the third row region relatively dark in color. The image fragment in the fifth row region is formed relatively light in color.

Accordingly, when macroscopically observing a printed image consisting of such raster lines, a streaky unevenness in darkness in the movement direction of the carriage becomes visually noticeable. This unevenness in darkness makes the print image quality deteriorate.

FIG. 9C is an explanatory diagram showing how dots are formed by the printing method of the present embodiment. In the present embodiment, for row regions which tend to be visually perceived darker in color, tone values of pixel data (CMYX pixel data) of pixels corresponding to those row regions are corrected in order to form image fragments lighter in color. Also, for row regions which tend to be visually perceived lighter in color, tone values of pixel data of pixels corresponding to those row regions are corrected in order to form image fragments darker in color. For example, in the figure, tone values of pixel data of the pixels corresponding to each row region are corrected in order to increase the generation rate of dots in the second row region, to decrease the generation rate of dots in the third row region, and to increase the generation rate of dots in the fifth row region. Thereby, the dot-generation rate of the raster line corresponding to each row region is changed, the darkness of the image fragment in the row region is corrected, and thus unevenness in darkness in the entire print image is suppressed.

Furthermore, in FIG. 9B, the image fragment formed in the third row region is darker in color, not because of effects of the nozzle that forms the raster line in the third row region, but because of effects of the nozzle that forms the raster line in the second row region contiguous thereto. Accordingly, if the nozzle that forms the raster line in the third row region forms a raster line in another row region, an image fragment formed in the other row region is not always darker in color. In short, there are cases in which there is difference in darkness even among image fragments formed by the same nozzle if image fragments contiguous to each of the above-mentioned fragments are formed respectively by different nozzles. In this case, correction values corresponding only to each nozzle cannot suppress unevenness in darkness. Thus, in the present embodiment, tone values of pixel data are corrected based on the correction values set for each row region.

Therefore, in the present embodiment, in the inspection processing at a printer manufacturing factory, a printer prints a correction pattern, the correction pattern is read with a scanner, and a correction value corresponding to each row region, which is based on darkness of each row region in the correction pattern, is stored in a memory of the printer. The correction values stored in the printer reflect characteristics of unevenness in darkness of each individual printer.

Then, under instructions by a user who has purchased the printer, the printer driver reads the correction values from the printer, tone values of pixel data are corrected based on the correction values, print data is generated based on the corrected tone values, and the printer performs printing based on the print data.

<Regarding Processing in Printer Manufacturing Factory>

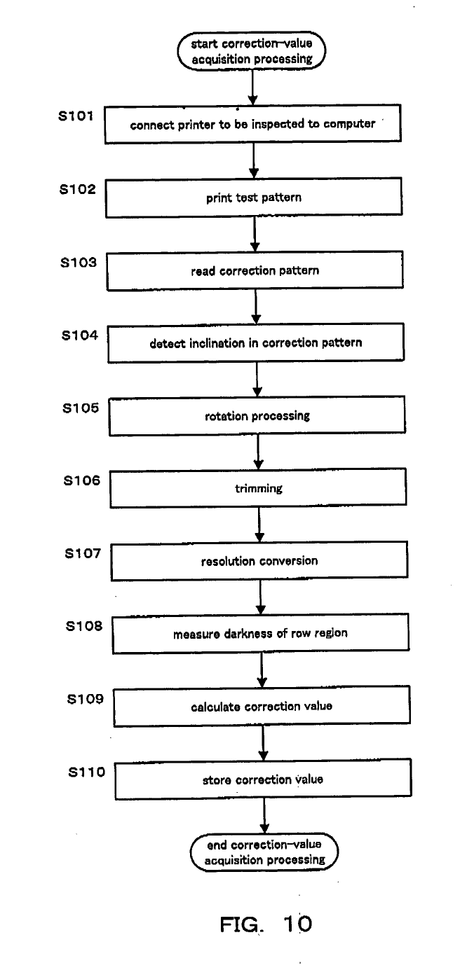

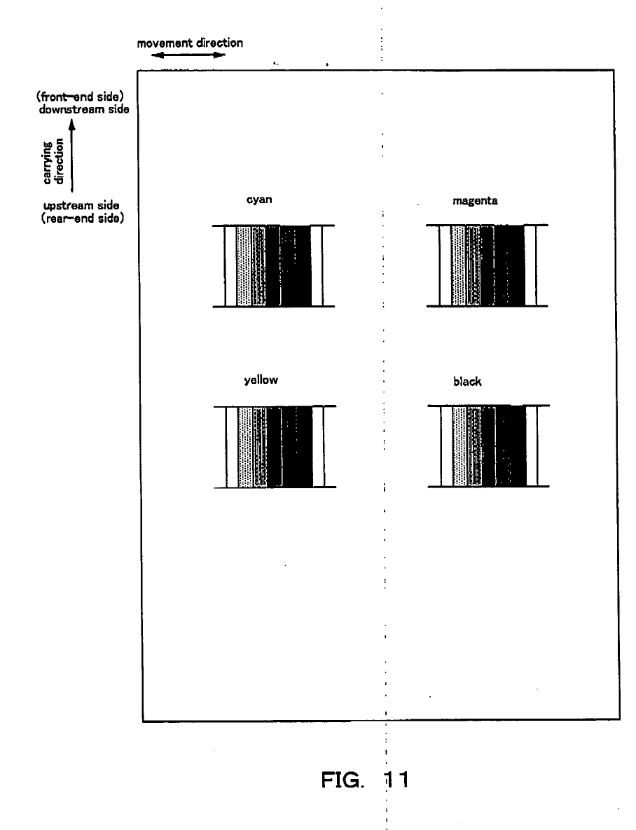

FIG. 10 is a flowchart of correction-value acquisition processing carried out during an inspection step after the printer has been manufactured.

First, an inspector connects a printer 1 to be inspected to a computer 110 in a factory (S101). The computer 110 in the factory is also connected to a scanner 150, and a printer driver for making the printer 1 print a test pattern, a scanner driver for controlling the scanner 150, and a correction-value acquiring program for performing image processing, analysis, and so forth, on the image data of the correction pattern read by the scanner are installed on the computer 110.

Next, the printer driver of the computer 110 makes the printer 1 print a test pattern (S102).

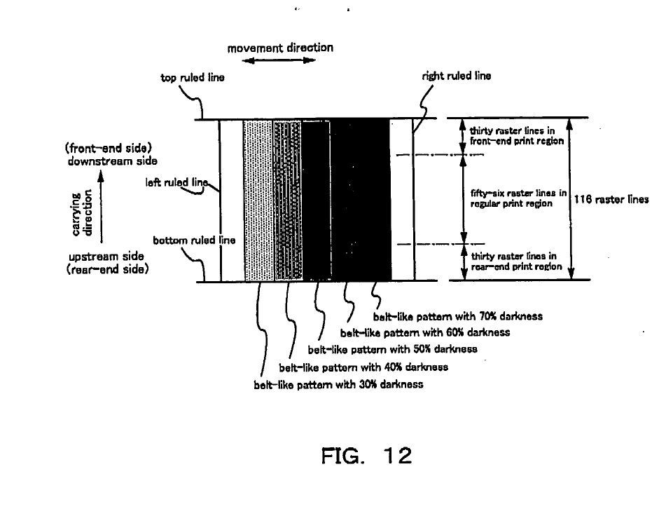

FIG. 11 is an explanatory diagram showing a test pattern. FIG. 12 is an explanatory diagram showing a correction pattern. Four correction patterns, each for a different color, are formed in the test pattern. Each correction pattern consists of belt-like patterns of five types of darkness, a top ruled line, a bottom ruled line, a left ruled line, and a right ruled line. Each belt-like pattern is generated from image data of a predetermined tone value. Starting from the left, the belt-like patterns respectively represent tone value 76 (darkness of 30%), tone value 102 (darkness of 40%), tone value 128 (darkness of 50%), tone value 153 (darkness of 60%), and tone value 179 (darkness of 70%), and they are lined up in the order from light to dark. It should be noted that the five types of tone values (darkness) are referred to as “designated tone values (designated darkness)”, and are expressed using the following symbols: Sa (=76), Sb (=102), Sc (=128), Sd (=153), and Se (=179). Each of the belt-like patterns is formed through the front-end printing, the regular printing, and the rear-end printing, and is therefore made up of raster lines in the front-end print region, raster lines in the regular print region, and raster lines in the rear-end print region. In usual printing, several thousands of raster lines are formed in the regular print region; however, when printing the correction patterns, eight cycles of raster lines are formed in the regular print region. For convenience of explanation, it is assumed that, in this example, the correction patterns are printed through the printing described in FIG. 8, and each belt-like pattern consists of a total of 116 raster lines, that is, thirty raster lines in the front-end print region, fifty-six raster lines (seven lines×eight cycles) in the regular print region, and thirty raster lines in the rear-end print region. The top ruled line is formed by the first raster line (the raster line on the side furthest downstream in the carrying direction) that makes up the belt-like patterns. On the other hand, the bottom ruled line is formed by the last raster line (the raster line on the side furthest upstream in the carrying direction) making up the belt-like patterns.

Next, the inspector places the test pattern printed by the printer 1 on the document platen glass 152 and closes the lid 151, to thereby set the test pattern to the scanner 150. Then, the scanner driver of the computer 110 makes the scanner 150 read the correction patterns (S103). Reading of the cyan correction pattern will be described below. (It should be noted that the correction patterns of the other colors are read in the same way.)

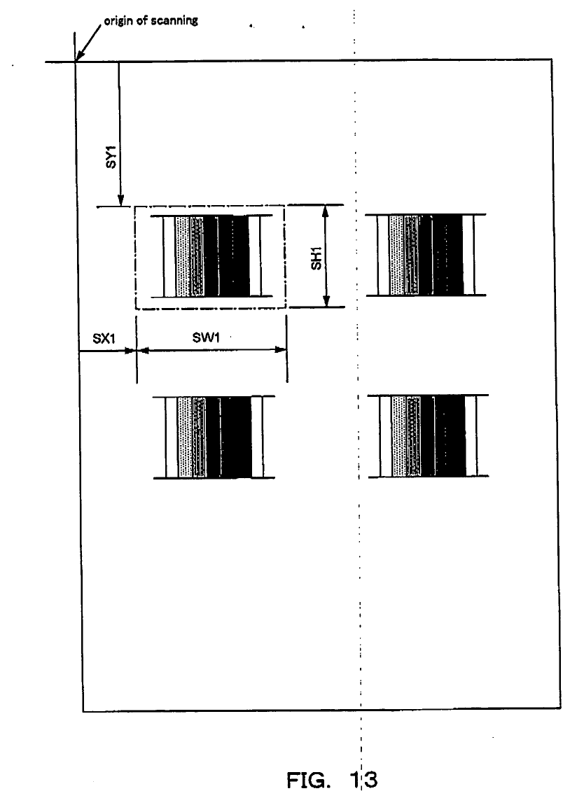

FIG. 13 is a diagram for describing a reading range for the cyan correction pattern. The range indicated by the alternate long-and-short dashed line surrounding the cyan correction pattern is the reading range for when reading the cyan correction pattern. Parameters SX1, SY1, Sw1, and SH1 for specifying this range are set in advance to the scanner driver by the correction-value acquiring program. By making the scanner 150 perform reading in this range, it is possible to read the entire cyan correction pattern, even in cases where the test pattern is set to the scanner 150 in a slightly misaligned state. Through this process, the image within the reading range shown in the figure is read by the computer 110 as rectangular image data having a resolution of 2880×2880 dpi.

Next, the correction-value acquiring program of the computer 110 finds the inclination θ in the correction pattern included in the image data (S104), and performs rotation processing on the image data in accordance with the inclination θ (S105).

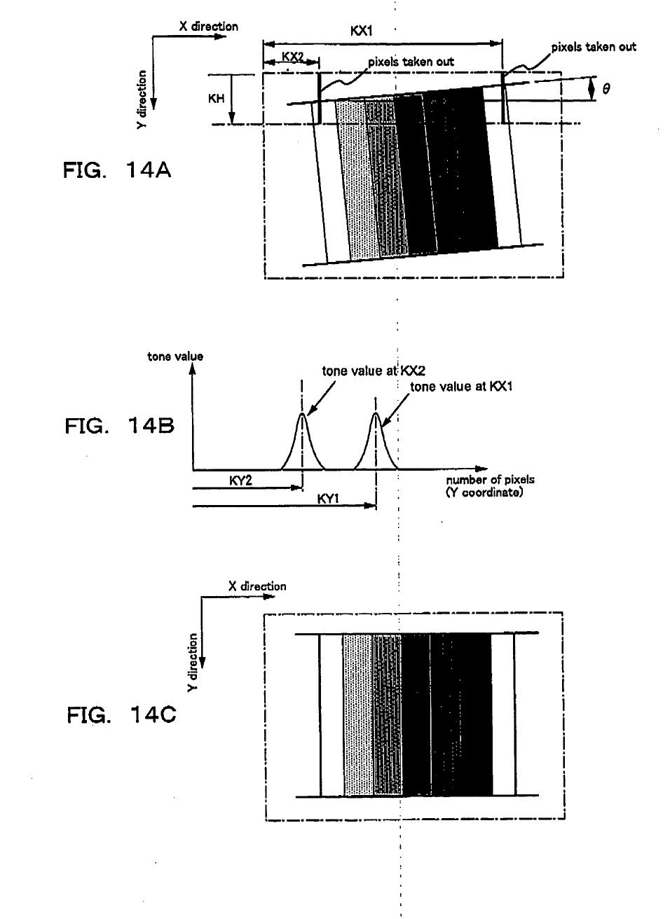

FIG. 14A is an explanatory diagram showing image data at the time of detecting the inclination. FIG. 14B is a diagram for describing how the position of the top ruled line is detected. FIG. 14C is an explanatory diagram showing image data after the rotation processing. The correction-value acquiring program takes out, from the image data that has been read, the pixel data of KH pieces of pixels from the top which are located at a distance of KX1 from the left, and the pixel data of KH pieces of pixels from the top which are located at a distance of KX2 from the left. The parameters KX1, KX2, and KH are set in advance such that the top ruled line is included in the pixels that are taken out at this time, but the right and left ruled lines are not. Then, in order to detect the position of the top ruled line, the correction-value acquiring program finds the respective barycentric positions KY1 and KY2 of the tone values of the KH pieces of pixel data that have been taken out. Then, based on the parameters KX1 and KX2 and the barycentric positions KY1 and KY2, the correction-value acquiring program calculates the inclination θ of the correction pattern using the following expression, and performs the image data rotation processing based on the calculated inclination θ:
θ=tan⁻¹{(KY2−KY1)/(KX2−KX1)}

Next, the correction-value acquiring program of the computer 110 trims unnecessary pixels from the image data (S106).

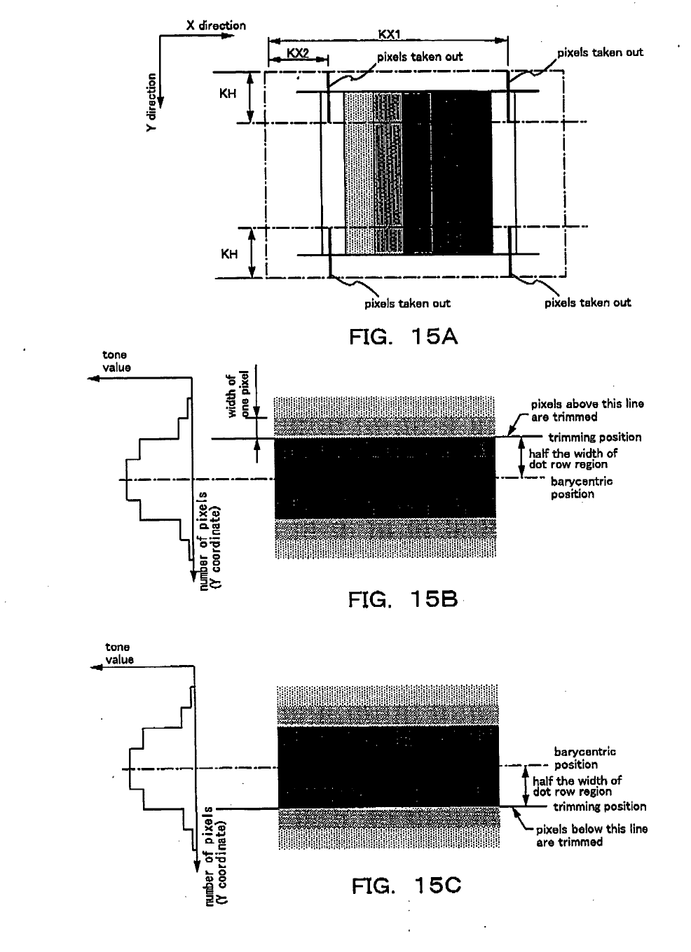

FIG. 15A is an explanatory diagram showing image data at the time of trimming. FIG. 15B is a diagram for describing the trimming position at the top ruled line. As with the processing in step S104, the correction-value acquiring program takes out, from the image data that has been subjected to the rotation processing, the pixel data of KH pieces of pixels from the top which are located at a distance of KX1 from the left, and the pixel data of KH pieces of pixels from the top which are located at a distance of KX2 from the left. Then, in order to detect the position of the top ruled line, the correction-value acquiring program finds the respective barycentric positions KY1 and KY2 of the tone values of the KH pieces of pixel data that have been taken out, and calculates the average value of the two barycentric positions. The program then determines, as the trimming position, the border between the pixels closest to a position located half the width of a row region upward from the barycentric position. It should be noted that, in this embodiment, half the width of a row region is equal to a width of two pixels, since the resolution of the image data is 2880 dpi and the width of the row region is 720 dpi. The correction-value acquiring program then executes the trimming by trimming the pixels located on the upper side from the trimming position that has been determined.

FIG. 15C is a diagram for describing the trimming position at the bottom ruled line. In a similar way as the top ruled line side, the correction-value acquiring program takes out, from the image data that has been subjected to the rotation processing, the pixel data of KH pieces of pixels from the bottom which are located at a distance of KX1 from the left and the pixel data of KH pieces of pixels from the bottom which are located at a distance of KX2 from the left, and calculates the barycentric position of the bottom ruled line. The program then determines, as the trimming position, the border between the pixels closest to a position located half the width of a row region downward from the barycentric position. The correction-value acquiring program then executes the trimming by trimming the pixels located on the lower side from the trimming position.

Next, the correction-value acquiring program of the computer 110 converts the resolution of the trimmed image data such that the number of pixels in the Y direction becomes 116 pieces (i.e., equal to the number of raster lines that make up the correction pattern) (S107).

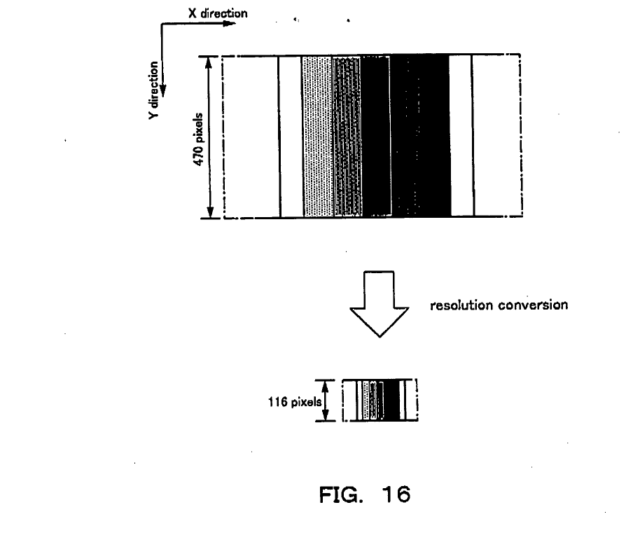

FIG. 16 is a diagram for describing resolution conversion. If the printer 1 ideally forms a correction pattern consisting of 116 raster lines at 720 dpi and the scanner 150 ideally reads the correction pattern at 2880 dpi (four times the resolution of the correction pattern), the number of pixels in the Y direction of the image data after trimming should be 464 (=116×4). In reality, however, there are cases in which the number of pixels in the Y direction of the image data does not become 464 due to influence of misalignment during printing and/or reading; in this example, it is assumed that the number of pixels in the Y direction of the image data after trimming is 470. The correction-value acquiring program of the computer 110 therefore performs resolution conversion (size-reduction processing) on the image data at a magnification of 116/470 (=“number of raster lines making up the correction pattern”/“number of pixels in the Y direction of the image data after trimming”). In this example, the Bicubic method is used for the resolution conversion. In this way, the number of pixels in the Y direction of the image data after resolution conversion becomes 116. In other words, the image data of the correction pattern in 2880 dpi is converted into image data of a correction pattern in 720 dpi. As a result, the number of pixels in the Y direction becomes equal to the number of row regions, and a row of pixels in the X direction will have a one-to-one correspondence with a row region. For example, the row of pixels in the X direction located at the top will correspond to the first row region, and the row of pixels located below the top row will correspond to the second row region. It should be noted that since this resolution conversion has the aim of changing the number of pixels in the Y direction to 116, resolution conversion (size-reduction processing) in the X direction need not be performed.

Next, the correction-value acquiring program of the computer 110 measures the darkness of each of the five types of belt-like patterns in each row region (S108). Below, explanation will be given on how the darkness in the first row region of the belt-like pattern on the left, which is formed at the tone value 76 (30% darkness), is measured. (It should be noted that measurement in the other row regions is performed in the same way. Further, measurement of the other belt-like patterns is also performed in the same way.)

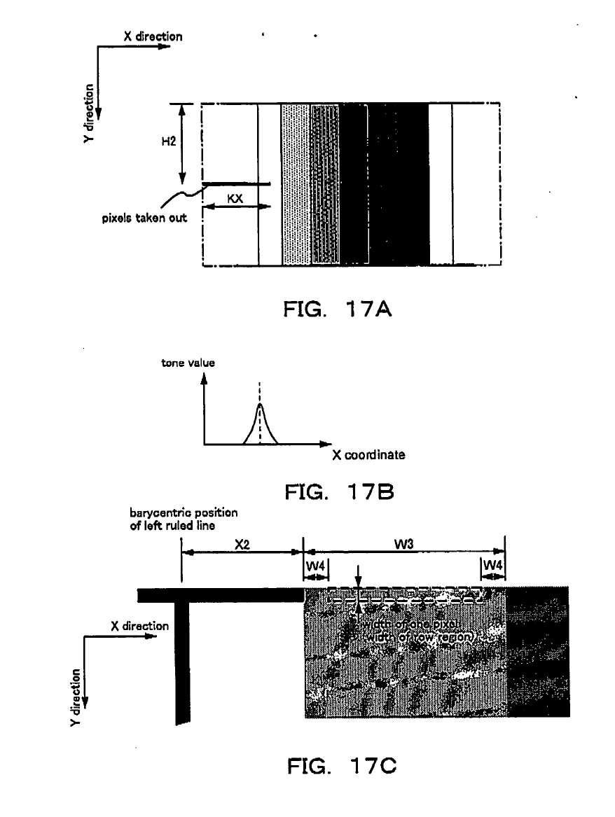

FIG. 17A is an explanatory diagram showing image data at the time of detecting the left ruled line. FIG. 17B is a diagram for describing how the position of the left ruled line is detected. FIG. 17C is a diagram for describing a measurement range for measuring the darkness in the first row region of the belt-like pattern having a darkness of 30%. The correction-value acquiring program takes out, from the image data that has been subjected to resolution conversion, pixel data of KX pieces of pixels from the left which are located at a distance of H2 from the top. The parameter KX is set in advance such that the left ruled line is included in the pixels that are taken out at this time. Then, in order to detect the position of the left ruled line, the correction-value acquiring program finds the barycentric position of the tone values of the pixel data of the KX pieces of pixels that have been taken out. It is known, from the shape of the correction pattern, that the belt-like pattern having a width of W3 and a darkness of 30% exists at a distance X2 to the right from the barycentric position (the position of the left ruled line). Therefore, taking the barycentric position as a reference, the correction-value acquiring program extracts the pixel data within a range surrounded by the dotted line in FIG. 17C, which is a range in which regions having a length of W4 on the right and left ends of the belt-like pattern have been excluded, and takes the average value of the tone values of the pixel data within that range as the measurement value of the first row region for 30% darkness. It should be noted that when measuring the darkness in the second row region of the belt-like pattern having a darkness of 30%, the pixel data within a range that is one pixel below the range shown by the dotted line in FIG. 17C are extracted. In this way, the correction-value acquiring program measures, for each row region, the darkness of the five types of belt-like patterns.

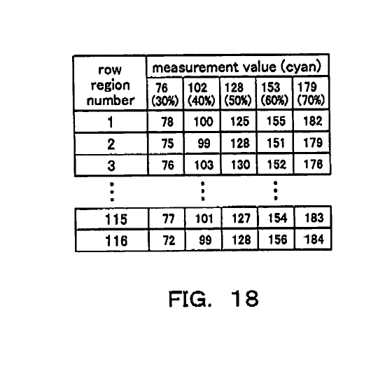

FIG. 18 is a measurement value table in which the results of measuring the darkness of the five types of belt-like patterns for cyan are summarized. As shown, the correction-value acquiring program of the computer 110 creates this measurement value table by correlating, with each row region, the measurement values of the darkness of the five types of belt-like patterns. Measurement value tables are created for the other colors as well. It should be noted that in the explanation below, measurement values for a certain row region in belt-like patterns having tone values of Sa to Se are indicated respectively as Ca to Ce.

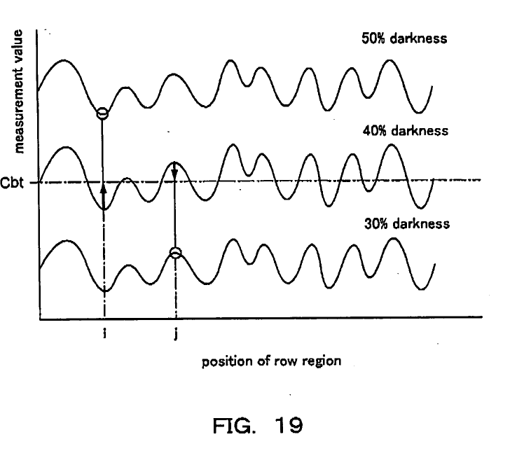

FIG. 19 is a graph showing the measurement values of the cyan belt-like patterns having 30% darkness, 40% darkness, and 50% darkness, respectively. Even though the belt-like patterns have been formed at their designated tone values in a uniform manner, it can be seen that there are differences in darkness among the row regions. These differences in darkness among the row regions are the cause of unevenness in darkness in a printed image.

In order to eliminate this unevenness in darkness, it is preferable that the measurement values in each belt-like pattern are fixed. Accordingly, here, the processing for making the measurement values in the belt-like pattern having the tone value Sb (40% darkness) be fixed will be discussed. In this example, the average value Cbt of the measurement values of all the row regions in the belt-like pattern for the tone value Sb is defined as the target value for 40% darkness. As for a row region i whose measurement value is lighter than the target value Cbt, it can be considered that correcting the tone value of the row region i toward the darker side would be suitable for making the darkness measurement value come closer to the target value Cbt. On the other hand, as for a row region j whose measurement value is darker than the target value Cbt, it can be considered that correcting the tone value of the row region j toward the lighter side would be suitable for making the darkness measurement value come closer to the target value Cbt.

Accordingly, the correction-value acquiring program of the computer 110 calculates correction values corresponding to the row regions (S109). Here, explanation will be given on a case in which a correction value for the designated tone value Sb in a certain row region is calculated. As described below, the correction value of the row region i for the designated tone value Sb (40% darkness) shown in FIG. 19 is calculated based on the measurement values for the tone value Sb and tone value Sc (50% darkness). On the other hand, the correction value of the row region j for the designated tone value Sb (40% darkness) is calculated based on the measurement values for the tone value Sb and tone value Sa (30% darkness).

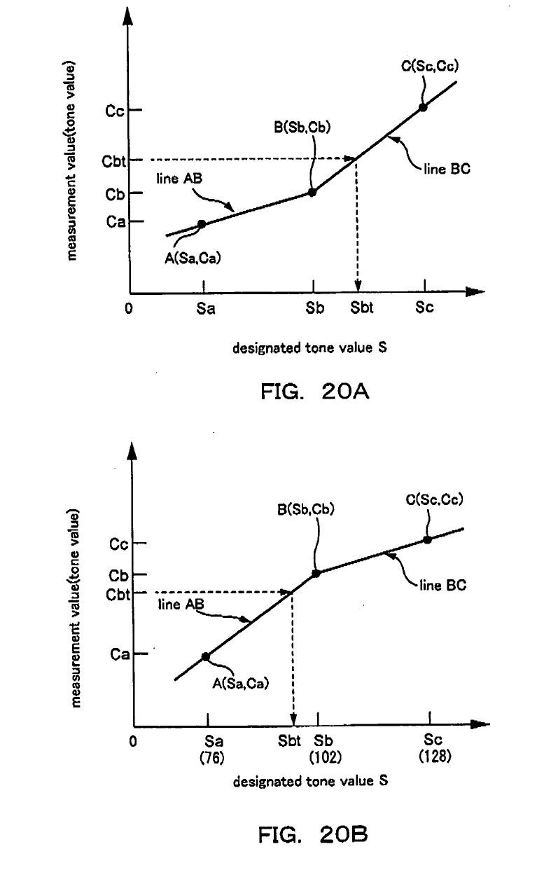

FIG. 20A is a diagram for describing a target designated tone value Sbt for the designated tone value Sb in the row region i. In this row region, the darkness measurement value Cb of the belt-like pattern formed at the designated tone value Sb indicates a tone value smaller than the target value Cbt. (That is, this row region is lighter than the average darkness of the belt-like pattern for 40% darkness.) If the printer driver is to make the printer form a pattern of a darkness corresponding to the target value Cbt in this row region, then it would be suitable for the printer driver to give an instruction based on the target designated tone value Sbt calculated according to the following expression (linear interpolation based on line BC):
Sbt=Sb+(Sc−Sb)×{(Cbt−Cb)/(Cc−Cb)}

FIG. 20B is a diagram for describing a target designated tone value Sbt for the designated tone value Sb in the row region j. In this row region, the darkness measurement value Cb of the belt-like pattern formed at the designated tone value Sb indicates a tone value larger than the target value Cbt. (That is, this row region is darker than the average darkness of the belt-like pattern for 40% darkness.) If the printer driver is to make the printer form a pattern of a darkness corresponding to the target value Cbt in this row region, then it would be suitable for the printer driver to give an instruction based on the target designated tone value Sbt calculated according to the following expression (linear interpolation based on line AB):
Sbt=Sb−(Sb−Sa)×{(Cbt−Cb)/(Ca−Cb)}

After calculating the target designated tone value Sbt in this way, the correction-value acquiring program calculates a correction value Hb for the designated tone value Sb in that row region according to the following expression:
Hb=(Sbt−Sb)/Sb

The correction-value acquiring program of the computer 110 calculates, for each row region, a correction value Hb for the tone value Sb (40% darkness). In the same way, the correction-value acquiring program calculates, for each row region, a correction value Hc for the tone value Sc (50% darkness) based on the measurement value Cc and the measurement value Cb or Cd for each row region. Further, in the same way, the correction-value acquiring program calculates, for each row region, a correction value Hd for the tone value Sd (60% darkness) based on the measurement value Cd and the measurement value Cc or Ce for each row region. The program also calculates, for each row region, three correction values (Hb, Hc, and Hd) for the other colors.

In the regular print region, there are fifty-six raster lines, and there is regularity for each set of seven raster lines. This regularity is taken into consideration in calculating the correction values of the regular print region.

When calculating the correction values for the first row region of the regular print region (the thirty-first row region of the entire print region), the correction-value acquiring program uses, as the above-described measurement value Ca, the average value of the measurement values for 30% darkness of eight row regions—first, eighth, fifteenth, twenty-second, twenty-ninth, thirty-sixth, forty-third, and fiftieth row regions—in the regular print region. Similarly, when calculating the correction values for the first row region of the regular print region (the thirty-first row region of the entire print region), the program uses, as the above-described measurement values Cb to Ce, the respective average values of the measurement values for each type of darkness of the eight row regions—first, eighth, fifteenth, twenty-second, twenty-ninth, thirty-sixth, forty-third, and fiftieth row regions—in the regular print region. Based on these measurement values Ca to Ce, the correction values (Hb, Hc, and Hd) of the first row region of the regular print region are calculated, as described above. In this way, the correction values for each row region in the regular print region are calculated based on an average of measurement values for each darkness of eight row regions, which are arranged at an interval of seven row regions. As a result, correction values are calculated only for the first to seventh row regions, and are not calculated for the eighth to fifty-sixth row regions. In other words, the correction values for the first to seventh row regions in the regular print region serve as the correction values for the eighth to fifty-sixth row regions.

Next, the correction-value acquiring program of the computer 110 stores the correction values in the memory 63 of the printer 1 (Sl10).

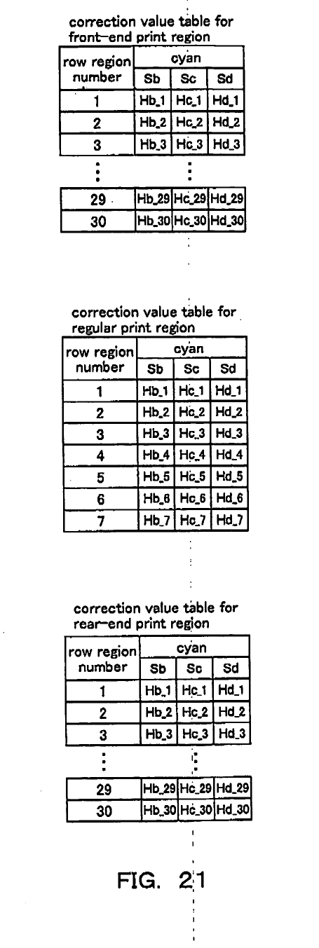

FIG. 21 is an explanatory diagram showing correction value tables for cyan. There are three types of correction value tables: a table for the front-end print region, a table for the regular print region, and a table for the rear-end print region. In each table, three correction values (Hb, Hc, and Hd) are correlated to each row region. For example, three correction values (Hb_n, Hc_n, and Hd_n) are associated with the n-th row region. The three correction values (Hb_n, Hc_n, and Hd_n) correspond to the designated tone values Sb (=102), Sc (=128), and Sd (=153), respectively. It should be noted that the correction value tables for the other colors are configured in the same way.

After storing the correction values in the memory 63 of the printer 1, the correction-value acquisition processing is terminated. Then, the printer 1 and the computer 110 are disconnected, and the printer 1 is shipped from the factory after other inspections on the printer 1 are finished. The printer 1 is shipped with a CD-ROM storing the printer driver.

<Regarding Processing Under Instructions by User>

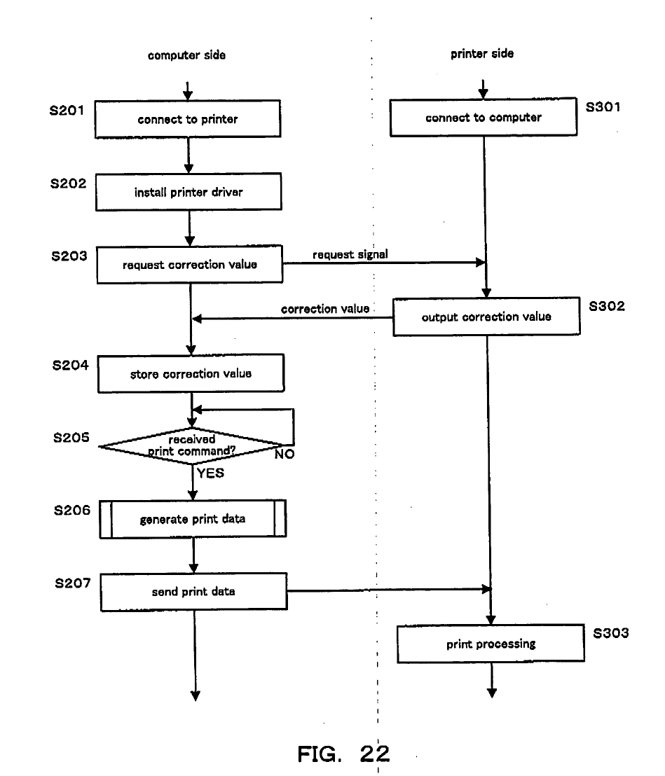

FIG. 22 is a flowchart showing processing performed under instructions by a user.

The user that has purchased the printer 1 connects the printer 1 to a computer 110 that he/she owns (which is different from the computer in the printer manufacturing factory) (S201, S301). It should be noted that the user's computer 110 does not have to be connected to a scanner 150.

Next, the user sets the CD-ROM packaged with the printer 1 to the record/play device 140 to install the printer driver (5202). The printer driver installed on the computer 110 makes the computer give out a request to the printer 1 to send the correction values (S203). In response to this request, the printer 1 sends to the computer 110 the correction value tables stored in its memory 63 (S302). The printer driver stores the correction values sent from the printer 1 in its memory (S204). In this way, the correction value tables are created also on the side of the computer. After processing up to this point is finished, the printer driver enters a standby state until there is a print command from the user (NO at S205).

When the printer driver receives a print command from the user (YES at S205), it generates print data in accordance with the correction values (S206), and sends the print data to the printer 1. The printer 1 then performs the print processing in accordance with the print data (S303).

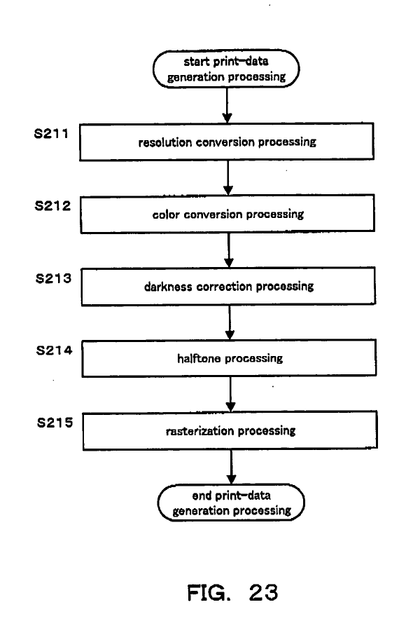

FIG. 23 is a flowchart of print-data generation processing. The processing is performed by the printer driver.

First, the printer driver performs resolution conversion processing (S211). The resolution conversion processing is a process for converting the resolution of image data (such as text data and image data) output from the application program to the resolution used at the time of performing printing on paper. For example, when the resolution for when performing printing on paper is designated as 720×720 dpi, the printer driver converts the image data received from the application program into image data having a resolution of 720×720 dpi. It should be noted that the image data after the resolution conversion processing is data (“RGB data”) having 256 tones expressed in the RGB color space.

Next, the printer driver performs color conversion processing (S212). The color conversion processing is a process for converting the RGB data into CMYK data expressed in the CMYK color space. The color conversion processing is performed by the printer driver referencing a table (a “color conversion lookup table LUT”) in which the tone values of the RGB data and the tone values of the CMYK data are associated. Through this color conversion processing, the RGB data for each pixel is converted into CMYK data, which corresponds to the ink color. It should be noted that data after the color conversion processing is CMYK data having 256 tones expressed in the CMYK color space.

Next, the printer driver performs darkness correction processing (S213). The darkness correction processing is a process for correcting the tone value of each pixel data based on the correction value(s) corresponding to the row region to which that pixel data belongs.

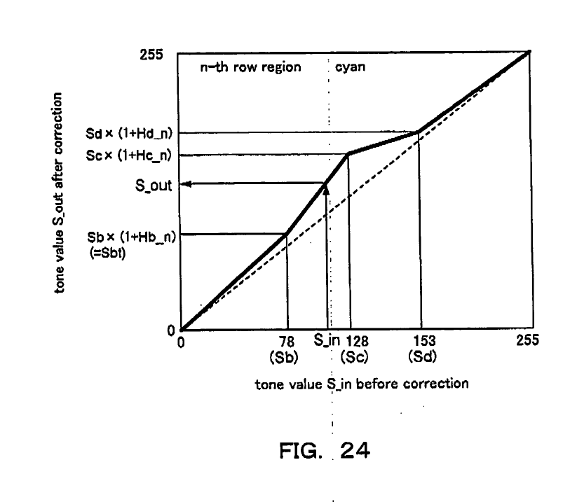

FIG. 24 is an explanatory diagram showing the darkness correction processing for an n-th row region for cyan. FIG. 24 shows how a tone value S_in of pixel data of a pixel belonging to the n-th row region for cyan is corrected. It should be noted that the tone value after correction is referred to as S_out.

When the tone value S_in of the pixel data before correction is the same as the designated tone value Sb, the printer driver can form an image at the target darkness Cbt in the unit region corresponding to that pixel data by correcting the tone value S_in to the target designated tone value Sbt. That is, if the tone value S_in of the pixel data before correction is the same as the designated tone value Sb, then it is preferable to correct the tone value S_in (=Sb) to Sb×(1+Hb) using the correction value Hb corresponding to the designated tone value Sb. Similarly, if the tone value S_in of the pixel data before correction is the same as the designated tone value Sc, then lit is preferable to correct the tone value S_in (=Sc) to Sc×(1+Hc).

On the contrary, when the tone value S_in before correction is different from the designated tone value, then the tone value S_out to be output is calculated using linear interpolation as shown in FIG. 24. In the linear interpolation shown in the figure, linear interpolation is performed between the tone values S_out after correction (Sbt, Sct, and Sdt) which correspond to the designated tone values (Sb, Sc, and Sd). This, however, is not a limitation. For example, it is possible to calculate a correction value H corresponding to the tone value S_in by performing linear interpolation between the correction values (Hb, Hc, and Hd) corresponding to the respective designated tone values and calculate the tone value after correction as S_in×(1+H) using the calculated correction value H.

As for the pixel data for the first to thirtieth row regions in the front-end print region, the printer driver performs the darkness correction processing based on the correction values corresponding to each of the first to thirtieth row regions, which are stored in the correction value table for the front-end print region. For example, as for the pixel data for the first row region in the front-end print region, the printer driver performs the darkness correction processing based on the correction values (Hb_1, Hc_1, and Hd_1) for the first row region in the correction value table for the front-end printing.

Similarly, as for the pixel data for the first to seventh row regions in the regular print region (the thirty-first to thirty-eighth row regions in the entire print region), the printer driver performs the darkness correction processing based on the correction values corresponding to each of the first to seventh row regions, which are stored in the correction value table for the regular print region. Note, however, that even though there are several thousands of row regions in the regular print region, correction values for only seven row regions are stored in the correction value table for the regular print region. Accordingly, as for the pixel data for the eighth to fourteenth row regions in the regular print region, the printer driver performs the darkness correction processing based on the correction values corresponding to each of the first to seventh row regions, which are stored in the correction value table for the regular print region. In this way, as for the row regions in the regular print region, the printer driver repeatedly uses, for every set of seven row regions, the correction values corresponding to each of the first to seventh row regions. Since there is regularity for each set of seven row regions in the regular print region, it can be considered that the characteristics regarding unevenness in darkness also repeat at the same cycle. Therefore, by repeatedly using the correction values at the same cycle, a reduction in the amount of data of correction values to be stored is achieved.

It should be noted that there are only fifty-six row regions in the regular print region of the correction pattern. However, the number of row regions in a regular print region of an image that is printed when the printer is in the hands of a user is much larger than fifty-six, and may amount to several thousands. The rear-end print region, which is made up of thirty row regions, is formed on the upstream side in the carrying direction (on the rear end side of the paper) from the above-described regular print region.

In the rear-end print region, as for the pixel data for the first to thirtieth row regions in the rear-end print region, the printer driver performs the darkness correction processing based on the correction values corresponding to each of the first to thirtieth row regions, which are stored in the correction value table for the rear-end print region, as in the front-end print region.

Through the darkness correction processing described above, as for a row region that is visually perceived to be dark, the tone value of pixel data (CMYK data) of a pixel corresponding to that row region is corrected such that it becomes smaller. On the other hand, as for a row region that is visually perceived to be light, the tone value of pixel data of a pixel corresponding to that row region is corrected such that it becomes larger. It should be noted that the printer driver performs the correction processing in the same way for the row regions for the other colors as well.

Next, the printer driver performs halftone processing (S214) The halftone processing is a process for converting data having a large number of tones into data having a number of tones that can be formed by a printer. For example, through the halftone processing, data indicating 256 tones is converted into one-bit data indicating two tones or two-bit data indicating four tones. In the halftone processing, dithering, y-correction, error diffusion, and so forth, are used to create pixel data such that the printer can form dots in a dispersed manner. When the printer driver performs the halftone processing, it references a dither table when using dithering, it references a gamma table when using γ-correction, and it references an error memory for storing diffused errors when using error diffusion. Data subjected to the halftone processing has the same resolution (for example, 720×720 dpi) as that of the RGB data described above.

In the present embodiment, the printer driver performs the halftone processing with respect to pixel data whose tone value has been corrected through the darkness correction processing. Since a row region that is visually perceived to be dark has been corrected such that the tone value of the pixel data in that row region becomes smaller, the dot-generation rate of dots that make up a raster line to be formed in that row region becomes lower. On the other hand, the dot-generation rate becomes higher for a row region that is visually perceived to be light in darkness.

Next, the printer driver performs rasterization processing (S215). The rasterization processing is a process for changing the matrix-like image data into the order in which they are to be transferred to the printer. Data subjected to the rasterization processing are output to the printer as the pixel data included in the print data.

When the printer performs the print processing in accordance with the print data generated in this way, the dot-generation rate of the raster line in each row region is changed as shown in FIG. 9C and the darkness of the image fragment in that row region is corrected, thereby suppressing unevenness in darkness in the entire printed image.

In the description above, the number of nozzles and the number of row regions (number of raster lines) are set to a small number in order to simplify the explanation. In practice, however, the number of nozzles is 180, and the number of row regions in, for example, the front-end print region becomes 360. Note, however, that the processing performed by the correction-value acquiring program, the printer driver, etc., is substantially the same.

===Image Processing of Present Embodiment===

<Regarding Error in Reading Position of Scanner>

In the present embodiment, the scanner 150 reads an image from a document at a resolution of 2880 dpi (main-scanning direction)×2880 dpi (sub-scanning direction). More specifically, every time the reading carriage 153 moves 1/2880 inch in the sub-scanning direction, the scanner 150 reads an image amounting to a single line from the line sensor 158. Accordingly, a line that is located one inch away from a reference line, which serves as a reference, is read as pixel data of pixels that are located 2880 pixels away in the sub-scanning direction from the pixels that make up the reference line. In other words, in terms of pixel data, a row of pixels (a pixel row) that is located 2880 pixels away in the sub-scanning direction from a pixel row that makes up the reference line constitutes an image that is located one inch away in the sub-scanning direction from the reference line.

However, if the precision in movement of the reading carriage 153 is not good, then an error in the reading position of the scanner 150 will occur, and the scanner 150 will not read the image data at a constant interval of 1/2880 inch.

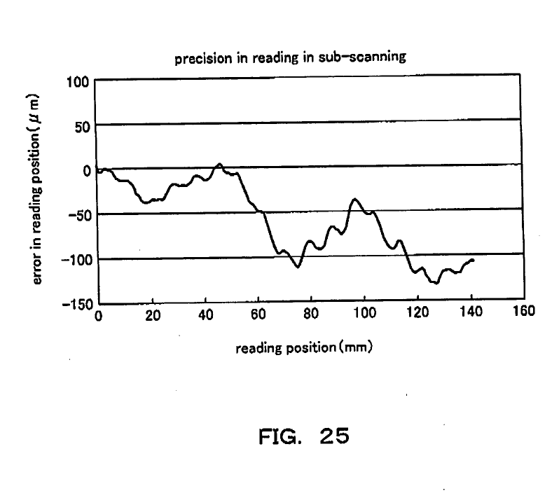

FIG. 25 is a graph showing an error in the reading position of the scanner. In this graph, the length of a single pixel is expressed as 1/2880 inch (approximately 8.9 μl). For example, assuming that the position at “0 mm” regarding the reading position is the position of the reference line, the error in the reading position is approximately −36 μm for a line that is located approximately one inch away from the reference line in the sub-scanning direction, which means that there is a deviation in position of approximately four pixels. For example, a pixel that is located 2880 pixels away in the sub-scanning direction from a pixel that indicates the reference line will represent an image that is positioned approximately −36 μm closer to the reference line than the position one inch away from the reference line in the sub-scanning direction.

Stated differently, at positions where the slope of the graph takes a negative value, an image is read at an interval that is shorter than 1/2880 inch (that is, read finely). On the other hand, at positions where the slope of the graph takes a positive value, an image is read at an interval that is longer than 1/2880 inch (that is, read roughly). It should be noted that at positions where the slope of the graph is approximately zero, an image is read at an interval of approximately 1/2880 inch.

Next, description will be made on how errors in the reading position affect the image data. A case in which the reading position of the scanner is correct will be described first, and then a case in which there is an error in the reading position will be described.

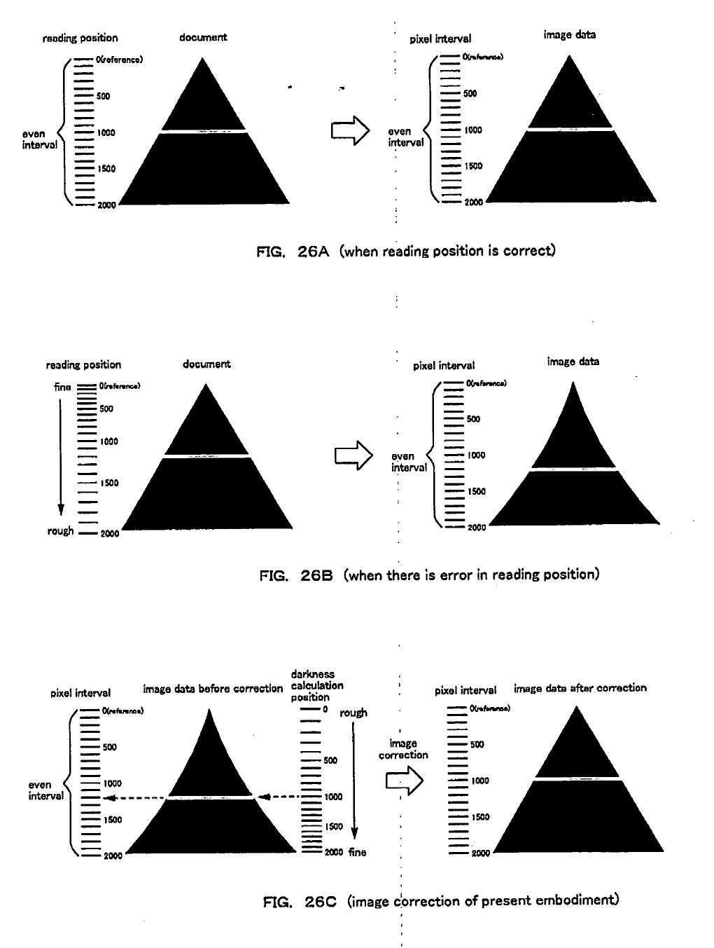

FIG. 26A is an explanatory diagram showing a relationship between a document and image data when the reading position of the scanner is correct. It should be noted that the reading carriage 153 moves relatively with respect to the document in the vertical direction in the figure. Further, an image that is expressed by the image data consists of square pixels, each having a size of 1/2880 inch (main-scanning direction)× 1/2880 inch (sub-scanning direction), lined up in the form of a matrix.

Here, for simplicity of explanation, it is assumed that the document has formed thereon an equilateral triangle whose height is approximately 2000/2880 inch, and not a correction pattern. Further, for the sake of explanation, a white line is formed at a position half the height of the equilateral triangle (i.e., at a position 1000/2880 inch away from the vertex of the equilateral triangle). In the description below, the position of the vertex of the equilateral triangle serves as the reference in the sub-scanning direction of the reading position, and the pixel at the vertex of the equilateral triangle serves as the reference of the positions of the pixels in the image data.

When the reading position of the scanner 150 is correct, the document is read at even intervals every time the reading carriage 153 moves 1/2880 inch in the sub-scanning direction (see the figure on the left). An image expressed by the image data read in this way looks just like the image on the document (see the figure on the right). It should be noted that the white line on the document is read at the 1001-st reading operation, and is read as pixel data of a pixel that is located 1000 pixels away from the reference pixel.

FIG. 26B is an explanatory diagram showing a relationship between a document and image data when there is an error in the reading position of the scanner. In this example, the image is read at an interval shorter than 1/2880 inch (that is, read finely) at positions close to the reference position, and the image is read at an interval longer than 1/2880 inch (that is, read roughly) at positions far from the reference position (see the figure on the left). An image expressed by the image data read in this way is deformed compared to the shape on the document (see the figure on the right). It should be noted that at the time of the 1001-st reading operation, an image positioned above the white line on the document is read (see the figure on the left). Further, the white line on the document is read at approximately the 1200-th reading operation (see the figure on the left), and is read as pixel data of a pixel that is located approximately 1200 pixels away from the reference pixel (see the figure on the right). Thus, the white line in the image data is positioned relatively on the lower side of the white line on the document.

In cases where the document has a correction pattern formed thereon, if there is an error in the reading position of the scanner, then the correction pattern cannot be read correctly, and thus, the correction-value acquiring program cannot measure the darkness of each of the row regions from the correction pattern properly. For example, if a certain raster line is read as being located at a position that is different from its actual position, then it would not be possible to measure the darkness of that raster line.

Accordingly, in the present embodiment, the image data that has been read by the scanner 150 is corrected in accordance with the characteristics of the scanner 150.

<Outline of Image Correction Processing of Present Embodiment>

FIG. 26C is an explanatory diagram showing image data before and after correction. The image correction processing is achieved by an image correction program making the computer 110 perform predetermined processes.

First, the image correction program reads, as image data, a linear scale (in other words, a rule or measure) in advance using the scanner 150. Slits, which serve as graduation markings, are provided in the linear scale. The image correction program obtains image data including these slits from the scanner 150. The image correction program then detects the positions of the slits in the image data and obtains “darkness calculation positions” (see the central section of FIG. 26C). For example, in a case where the interval of the reading positions changes from fine to rough as shown in the figure on the left of FIG. 26B, the darkness calculation positions are calculated so that they change from rough to fine. Further, for example, the 1000-th darkness calculation position is calculated as a position corresponding to approximately the 1200-th pixel. It should be noted that processing from reading of the linear scale up to calculation of the darkness calculation positions is referred to as “pre-processing”.

Next, using the scanner 150, the image correction program acquires image data of the document. The image correction program then corrects the image data of the document based on the darkness calculation positions obtained in the pre-processing. For example, pixel data of a pixel located 1000 pixels away from the reference pixel is calculated based on pixel data of a pixel in the vicinity of the 1200-th pixel which corresponds to the 1000-th darkness calculation position. It should be noted that processing from reading of the document up to correction of the image data of the document is referred to as “post-processing”.

An image expressed by the corrected image data looks just like the image on the document (see the figure on the right in FIG. 26C). For example, the white line in the corrected image data becomes pixel data of pixels located 1000 pixels away from the reference pixel. In cases where the document has a correction pattern printed thereon, even if there is an error in the reading position of the scanner, correct image data of the correction pattern can be acquired. Therefore, the correction-value acquiring program can correctly measure the darkness of each of the row regions from the correction pattern.

Image processing according to the present embodiment is described in detail below.

<Regarding Pre-Processing>

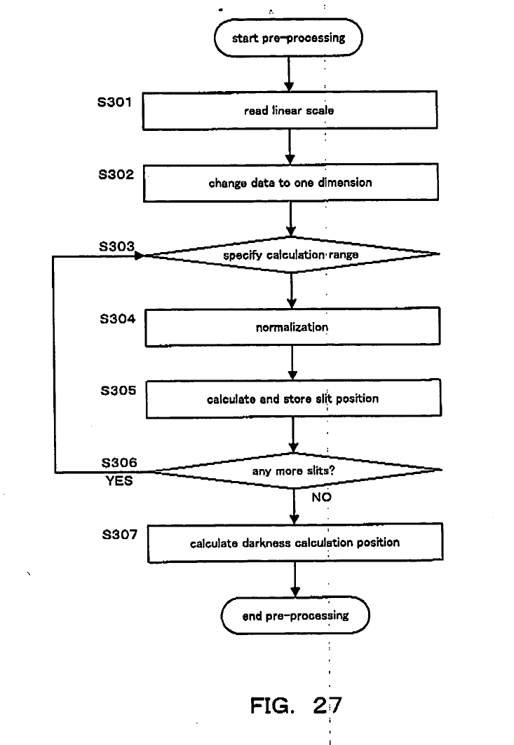

FIG. 27 is a flowchart of the pre-processing. The processes in the pre-processing are described below. The pre-processing is performed, for example, in a printer manufacturing factory once every day, or every time a printer manufacturing line is started

First, the image correction program reads, as image data, a linear scale using the scanner 150 (S301). It should be noted that the linear scale used in this process is the same as that used as the linear encoder 51.

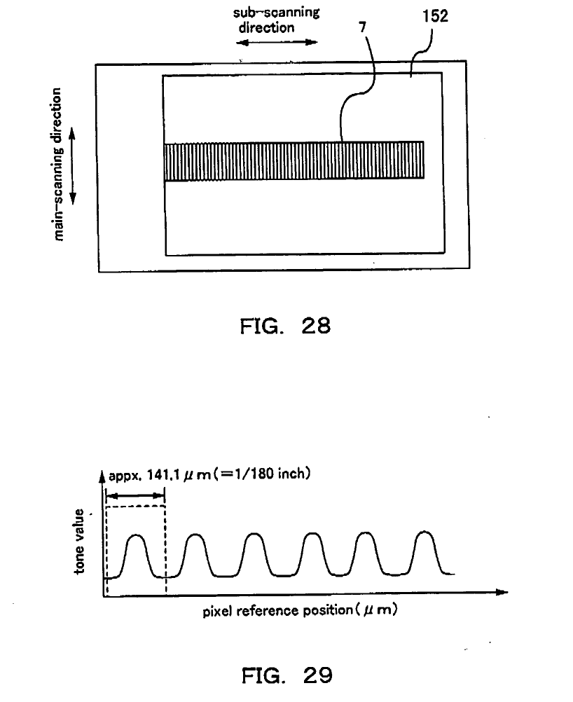

FIG. 28 is an explanatory diagram showing how the linear scale 7 is placed on the document platen glass 152 of the scanner 150. The linear scale 7 has slits provided therein at an interval of 1/180 inch. The linear scale 7 is placed on the document platen glass 152 such that these slits are lined up in the sub-scanning direction of the scanner 150. Stated differently, the linear scale 7 is placed on the document platen glass 152 such that the slits are arranged in the same direction as the direction in which the row regions of a correction pattern are aligned when a test pattern is placed on the document platen glass 152.

The scanner 150 reads, as image data, the linear scale 7 at a resolution of 2880 dpi (main-scanning direction)×2880 dpi (sub-scanning direction). The image data read by the scanner consists of pixel data of pixels arranged in a two-dimensional plane in the main-scanning direction and the sub-scanning direction. Each piece of pixel data is monochrome data, and has a tone value in 256 tone levels. It should be noted that if there is an error in the reading position of the scanner, the image data of the linear scale 7 is obtained in that state. In other words, if there is an error in the reading position of the scanner, the linear scale expressed by the image data will have a shape that is different from the actual linear scale.

Next, the image correction program averages the pixel data of the pixels lined up in the main-scanning direction of the two-dimensional image data (S302). In this way, one-dimensional image data in the sub-scanning direction is created. The one-dimensional image data consists of pixel data of pixels lined up at 2880 dpi in the sub-scanning direction.

FIG. 29 is a graph showing the one-dimensional image data of the linear scale. The vertical axis of the graph indicates the tone values, whereas the horizontal axis indicates “pixel reference positions”. The pixel reference positions of the horizontal axis are calculated based on the positions of the pixels in the image data. For example, the position of a pixel that is located ten pixels away from the reference pixel is calculated to be 88.2 μm (≈( 1/2880 inch)×10). Therefore, if there is an error in the reading position of the scanner, there will be an error between the actual reading position and the pixel reference position.

Since the linear scale has slits provided at an interval of 1/180 inch, peaks appear in the graph at an interval of approximately 141.1 m ( 1/180 inch). If, however, there is an error in the reading position of the scanner, then the interval of the slits (the interval of the peaks) in terms of the pixel reference positions does not always become 141.1 μm. Accordingly, the image correction program calculates the barycentric position of each peak (the position of each slit) in terms of the pixel reference positions through the processes 5302 through S306 below.

First, the image correction program takes out, as a calculation range, pixel data of sixteen pixels (range of 1/180 inch; range surrounded by dotted lines in FIG. 29) including the first peak.

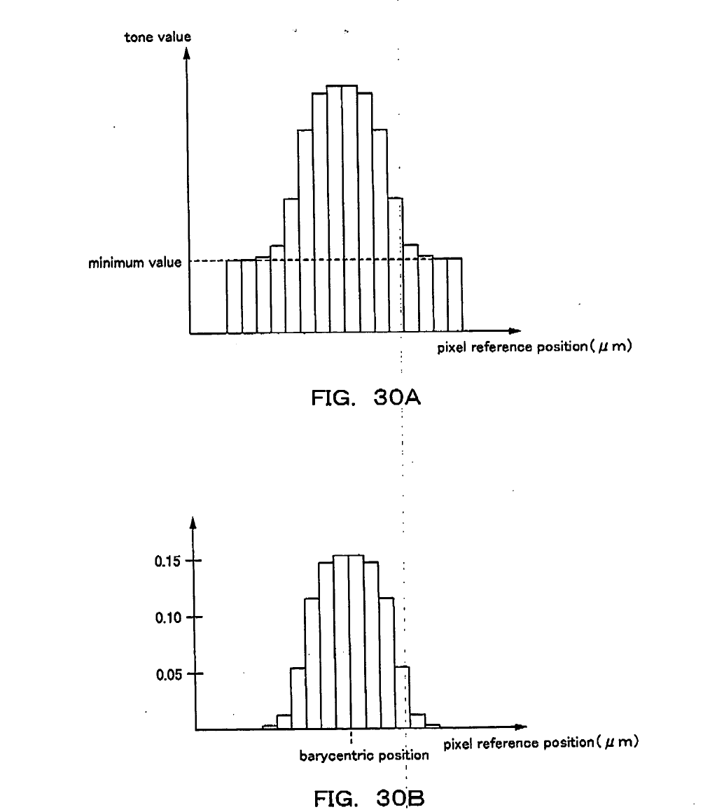

FIG. 30A is an explanatory diagram showing pixel data of the sixteen pixels that have been taken out. The image correction program obtains a minimum value among these pieces of pixel data, and “offsets” each piece of pixel data with the minimum value (that is, subtracts the minimum value from the value of each piece of pixel data). In this way, the minimum value of the pixel data becomes zero.

The image correction program then performs normalization of the sixteen pieces of pixel data (S304). Normalization is achieved by obtaining the sum of the tone values of all of the pixel data and dividing the value of each pixel data by the sum. In this way, the sum of the pixel data after normalization becomes “1”.

FIG. 30B is an explanatory diagram showing normalized pixel data. The image correction program obtains, as the position of a slit, the barycentric position of the normalized pixel data. Since the pixel data have been normalized, the total sum of products obtained by multiplying the value of the pixel data and the pixel reference position pixel-by-pixel becomes the barycentric position. Note, however, that this barycentric position is a position in terms of the pixel reference positions. The image correction program stores the calculated barycentric position as the position of the slit in the calculation range (S305).

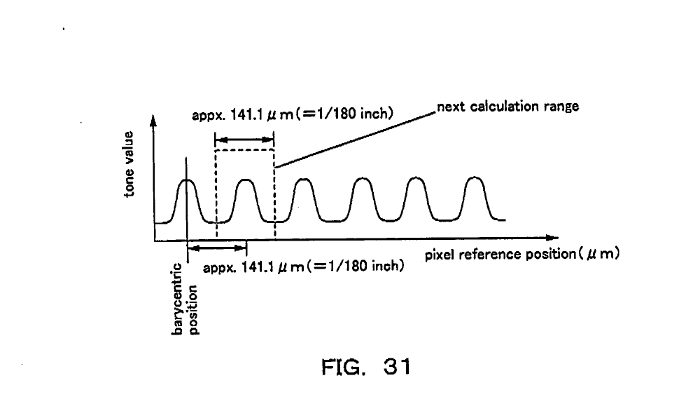

FIG. 31 is an explanatory diagram showing the next calculation range. After calculating the position of the first slit, the image correction program specifies the next calculation range. The image correction program takes out, as the calculation range, pixel data of sixteen pixels (range of 1/180 inch; range surrounded by dotted lines in FIG. 31) such that the position that is located 1/180 inch away from the previously-calculated barycentric position comes in the center. The program repeats the same processes as those described above to sequentially obtain the positions of the slits in terms of the pixel reference position.

It should be noted that due to an error in the reading position of the scanner, there are instances in which the interval of the slits is not 1/180 inch (≈141.1 μm) in terms of the pixel reference positions. However, an error included in a length of 1/180 inch is extremely small. Therefore, a slit would certainly exist in a range defined by taking out pixel data of sixteen pixels with the position 1/180 inch away from the position of an adjacent slit located in the center.

Even if the interval of the slits in terms of the pixel reference positions is not 1/180 inch (≈141.1 μm), the actual interval of the slits in the linear scale 7 is precisely 1/180 inch (≈141.1 μm). Therefore, even if image data is taken in from a document in a state in which there is an error in the reading position of the scanner 150, it is possible to obtain the image on the document at the actual 1/180-inch interval by extracting, from such image data, pixel data corresponding to the positions of the slits in terms of the pixel reference positions.

However, only image data with a low resolution of 180 dpi can be obtained simply by extracting, from the image data, pixel data corresponding to the positions of the slits. Accordingly, the image correction program calculates darkness calculation positions at an interval of approximately 1/2880 inch based on the information of the positions of the slits in terms of the pixel reference positions (S307).

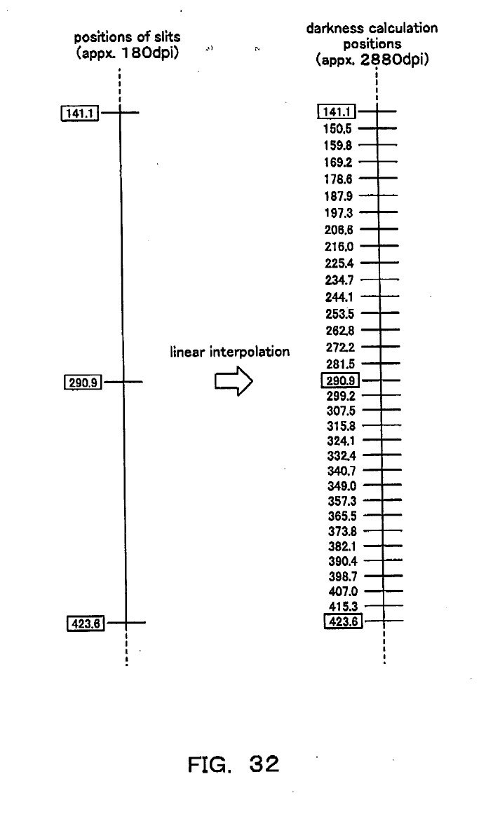

FIG. 32 is an explanatory diagram describing how to calculate the darkness calculation positions. For example, the image correction program has information on positions, such as “141.1 μm”, “290.9 μm”, and “423.6 μm”, as the positions of the slits. Based on these values, the image correction program calculates positions of fifteen points between “141.1 μm” and “290.9 μm” through linear interpolation. In the same way, the image correction program calculates positions of fifteen points between “290.9 μm” and “423.6 μm” through linear interpolation. By calculating positions of fifteen points between positions of adjacent slits through linear interpolation as described above, the image correction program can calculate positions at an interval of approximately 1/2880 inch. In the present embodiment, the positions that have been calculated in this way are regarded as the “darkness calculation positions”. It should be noted that these darkness calculation positions reflect the reading error of the scanner 150 and are values specific to each scanner 150.

The image correction program stores the calculated darkness calculation positions in a memory of the computer 110. In the post-processing described below, the image correction program refers to the darkness calculation positions stored in the memory. It is possible, however, to only store the positions of the slits in the memory of the computer 110, without obtaining the darkness calculation positions in the pre-processing. In such a case, the image correction program first obtains the darkness calculation positions based on the positions of the slits stored in the memory before performing the post-processing.

Due to an error in the reading position of the scanner 150, there are cases in which the interval of the darkness calculation positions is not 1/2880 inch (≈8.9 μm) in terms of the pixel reference positions. However, by extracting, from the image data, pixel data corresponding to the darkness calculation positions in terms of the pixel reference positions, it is possible to obtain the image on the document at the actual 1/2880-inch interval.

Accordingly, in the post-processing described below, the image correction program extracts, from the image data read from the document, pixel data corresponding to the darkness calculation positions, to correct the image data.

<Regarding Post-processing>

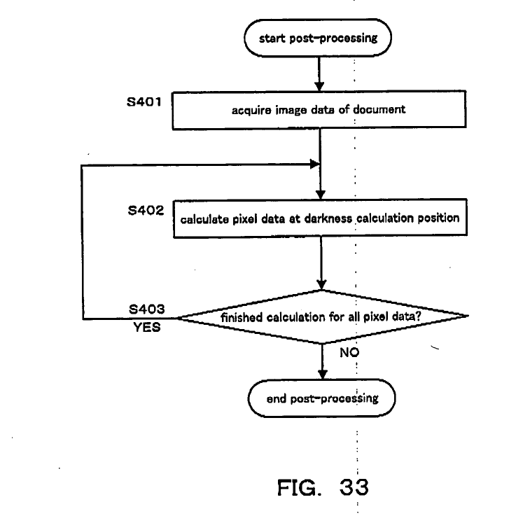

FIG. 33 is a flowchart of the post-processing.

First, the image correction program acquires image data of a document at a resolution of 2880 dpi (main-scanning direction) x2880 dpi (sub-scanning direction) (S401). For example, the image correction program acquires the image data of the correction pattern that the scanner driver read with the scanner 150 in S103 of FIG. 10. The image correction program then performs image correction on the image data.

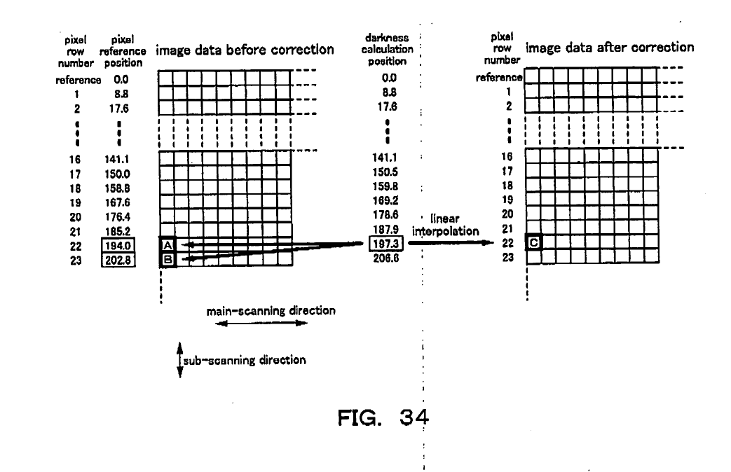

FIG. 34 is an explanatory diagram showing how the image data is corrected. This figure is similar to the explanatory diagram regarding image correction of FIG. 26C. Although FIG. 26C shows how to extract pixel data corresponding to the 1000-th darkness calculation position, FIG. 34 shows how to extract pixel data corresponding to the twenty-second darkness calculation position.

The diagram on the left in the figure shows the image data before correction, and the diagram on the right in the figure shows image data after correction. Both image data have a resolution of 2880 dpi (main-scanning direction)×2880 dpi (sub-scanning direction), and consist of pixel data arranged in a matrix along the main-scanning direction and the sub-scanning direction. In this example, the first reading position and the pixel row of the pixel data read at this position are used as a reference.

An image expressed by the image data consists of square pixels, each having a size of 1/2880 inch (main-scanning direction)× 1/2880 inch (sub-scanning direction), lined up in the form of a matrix. Accordingly, the pixel reference position in the sub-scanning direction of the n-th pixel row in the sub-scanning direction is (n-1)/2880 inch. For example, the pixel reference position in the sub-scanning direction of the second pixel row is 8.8 m (≈ 1/2880 inch).

Then, the image correction program calculates the pixel data of the n-th pixel row by extracting, from the image data (data before correction), the pixel data corresponding to the n-th darkness calculation position (S402).

For example, the sixteenth darkness calculation position “141.1 μm” is the same as the pixel reference position of the sixteenth pixel row. In such a case, the pixel data of the sixteenth pixel row in the uncorrected image data (image data before correction) becomes the pixel data of the sixteenth pixel row in the corrected image data (image data after correction). That is, if there is a pixel row whose pixel reference position is the same as the darkness calculation position as in the case described above, then the pixel data of that pixel row is used, as it is, as the pixel data that makes up the corrected image data.

However, in cases where there is an error in the reading position of the scanner 150, it is rare that the darkness calculation position and the pixel reference position become the same. For example, the twenty-second darkness calculation position “197.3 μm” comes between the twenty-second pixel reference position “194.0 μm” and the twenty-third pixel reference position “202.8 μl”. As described above, often, the darkness calculation position comes between pixel reference positions of two pixel rows.

In such cases, the image correction program calculates the pixel data corresponding to the darkness calculation position through linear interpolation. For example, the image correction program calculates the pixel data corresponding to the darkness calculation position “197.3 μm” through linear interpolation using the pixel data of the twenty-second pixel reference position “194.0 μm” and the pixel data of the twenty-third pixel reference position “202.8 μm”. More specifically, as shown in FIG. 34, the image correction program calculates, using the following expression, a value C of the pixel data corresponding to the darkness calculation position “197.3 μm”, based on a value A of the pixel data of the twenty-second pixel reference position “194.0 μm” and a value B of the pixel data of the twenty-third pixel reference position “202.8 μm”:
C=A+(B−A)×(197.3−194.0)/(202.8−194.0)

In this way, the image correction program calculates each piece of pixel data that make up the corrected image data by performing linear interpolation with respect to the pixel data of the uncorrected image data based on the darkness calculation positions (S402 and 5403). The corrected image data reflects the image on the document at the actual 1/2880-inch interval, even when there is an error in the reading position of the scanner 150.

If, for example, a document has a test pattern printed thereon, the image correction program transfers the corrected image data of the correction pattern to the correction-value acquiring program, and the correction-value acquiring program performs processing, such as rotation processing (S105), trimming (S106), and resolution conversion (S107), with respect to the corrected image data of the correction pattern. In this way, the correction-value acquiring program can correctly measure the darkness of each row region of the correction pattern.

===Other Embodiments===

Although the printer 1 and the printing system 100 according to embodiments thereof are described above, the above-mentioned embodiments are provided for facilitating the understanding of the invention, and are not to be interpreted as limiting the invention. As a matter of course, the invention can be altered and improved without departing from the gist thereof and the invention includes equivalent thereof.

For example, the above-mentioned printer 1 is a separate unit from the scanner 150. However, a multifunction machine into which a printer and a scanner are incorporated can be used.

In the above-mentioned embodiments, the test pattern is printed and the correction value tables are created on the inspection process in manufacturing of the printer 1, but the invention is not limited thereto. For example, a user who has purchased the printer 1 can print a test pattern with the printer 1, read the test pattern with the scanner 150, and create the correction value tables. In this case, the printer driver can include the correction-value acquiring program.

Furthermore, in the above-mentioned embodiments, one raster line is formed by one nozzle, but the invention is not limited thereto. For example, one raster line can be formed by two nozzles.

===Conclusion===

(1) In cases where there is an error in the reading position of the scanner 150, when the scanner 150 reads an image on a document, an image expressed by image data of the document will have a shape that is different from the image on the document (see FIG. 26B). Accordingly, the image correction program of the present embodiment first reads, as image data, a linear scale 7 (an example of a “scale”) with the scanner in the pre-processing (an example of a “first reading step”; see S301 of FIG. 27). Then, the image correction program reads, as image data, a document with the scanner (an example of a “second reading step”), and then it corrects the image data of the document using the image data of the linear scale 7. More specifically, the image correction program obtains darkness calculation positions (see FIG. 26C, FIG. 32, and FIG. 34) using the image data of the linear scale 7, and extracts, from the image data of the document, pixel data corresponding to the darkness calculation positions, to thereby correct the image data of the document.

In this way, it is possible to correct the image data of the document such that the image expressed by the image data becomes similar to the image on the document, even when there is an error in the reading position of the scanner 150.

(2) In the foregoing embodiment, the image correction program detects the positions of the slits (an example of “graduation markings”) in the linear scale 7 based on the image data of the linear scale 7 (see S305 of FIG. 27). If there is an error in the reading position of the scanner 150, the positions of the slits detected in this step will also deviate from the actual positions of the slits. However, by correcting the image data of the document based on the positions of the slits that are different from the actual slit positions, it is possible to perform correction such that the image data of an image that is different from the actual image becomes similar to the actual image.

(3) If the position of a slit is the same as the pixel reference position of the n-th pixel row, then the pixel data of the n-th pixel row are extracted as is. However, in cases where there is an error in the reading position of the scanner 150, it is rare that the position of the slit and the pixel reference position become the same. In such cases, in the foregoing embodiment, pixel data corresponding to the positions of the slits, among pieces of pixel data that make up the corrected image data, are calculated in the post-processing based on the image data of the document. Here, “pixel data corresponding to the position of a slit among the plurality of pieces of the pixel data that make up the corrected image data” is, for example, the pixel data of the sixteenth pixel row or the pixel data of the thirty-second pixel row (not shown), which make up the corrected image data, as shown in FIG. 34.

The actual interval of slits in the linear scale 7 is precisely 1/180 inch (≈141.1 μm) Therefore, even when image data is taken in from a document in a state where there is an error in the reading position of the scanner 150, it is possible to obtain the image of the document at the actual 1/180-inch interval by extracting, from the image data, pixel data corresponding to the positions of the slits in terms of the pixel reference positions.

It should be noted that in the foregoing embodiment, the positions of the slits, the darkness calculation positions, etc., are described in terms of the pixel reference positions. This, however, is not a limitation, and for example, the slit positions and the darkness calculation positions may be indicated on the basis of pixel numbers, for example.

(4) In the foregoing embodiment, linear interpolation is performed in calculating, from the image data of the document, the data corresponding to the positions of the slits in the linear scale 7. This, however, is not a limitation, and for example, bicubic interpolation may be adopted.

(5) Incidentally, the resolution of the image data after correction becomes low if pixel data corresponding to the positions of the slits are simply calculated from the image data. However, if the interval of the slits in the linear scale is changed from 180 dpi to 2880 dpi, it becomes necessary to increase the reading resolution of the scanner 150, or it would become difficult to detect the positions of the slits from the image data of the linear scale.

Accordingly, in the foregoing embodiment, the darkness calculation positions at an interval of 1/2880 inch are obtained based on the positions of the slits detected at an interval of approximately 1/180 inch. The image correction program then corrects the image data of the document based on the darkness calculation positions.

In this way, it is possible to increase the resolution of the corrected image data.

(6) In the foregoing embodiment, the darkness calculation positions are obtained based on the positions of the slits through linear interpolation. The method, however, is not limited to linear interpolation. For example, the darkness calculation positions may be obtained using bicubic interpolation.

(7) The above-described scanner 150 has a line sensor 158 (see FIG. 5A) for reading an image, and a reading carriage 153 that makes the line sensor 158 move in the sub-scanning direction. In cases where the precision in movement of the reading carriage is not good, an error occurs in the reading position of the scanner 150 in the sub-scanning direction, and as a result, the image expressed by the image data becomes deformed in the sub-scanning direction compared to the image on the document.

Accordingly, in the foregoing embodiment, the linear scale 7 is placed on the document platen glass in the sub-scanning direction, and the scanner 150 reads this linear scale. In this way, it becomes possible to correct the deformation in the sub-scanning direction of the image data of the document based on the image data of the linear scale 7.

It should be noted that in cases where there is an error in the reading position in the main-scanning direction of the line sensor 158 and the deformation in the main-scanning direction of the image data due to effects of such an error is to be corrected, the linear scale 7 may be placed on the document platen glass in the main-scanning direction, the linear scale oriented in this way may be read by the scanner 150, and the image data of the document may be corrected based on the positions, in the main-scanning direction, of the slits in the linear scale. However, considering the structure of the scanner 150 that moves the line sensor in the sub-scanning direction, the image data of the document is more likely to deform in the sub-scanning direction than in the main-scanning direction.

(8) In the foregoing embodiment, the document has, for example, a correction pattern formed thereon. As shown in FIG. 12, the correction pattern is made up of a plurality of raster lines (an example of “dot rows”). The raster lines are formed by ejection of ink from nozzles that move in the movement direction, and these raster lines are formed in corresponding row regions, each of which being aligned in the movement direction.

In cases where the correction pattern is read in a state where there is an error in the reading position of the scanner 150, the image expressed by the image data of the correction pattern becomes deformed in the sub-scanning direction. If the image data is deformed in the sub-scanning direction in this way, the row regions in the image data deviate from the row regions in the correction pattern, and thus, it becomes difficult for the correction-value acquiring program to measure the darkness of the row regions of the correction pattern.

Accordingly, in the foregoing embodiment, the image correction program corrects the deformation in the sub-scanning direction of the image data of the correction pattern, and then, the correction-value acquiring program measures the darkness of each row region based on the image data of the correction pattern that has been corrected. Since the deformation in the sub-scanning direction of the image data of the correction pattern is corrected by the image correction program, the row regions of the image data correspond properly to the row regions of the correction pattern. Therefore, the correction-value acquiring program can properly measure the darkness of the row regions of the correction pattern.

(9) An image processing method including all of the above-described elements is preferable because all of the advantages can be achieved. However, it is not absolutely necessary for the method to include all of the elements. In short, it is only necessary that the image data can be corrected such that the image expressed by the corrected image data becomes similar to the image on the document.

(10) In the foregoing embodiment, the image correction program corrects the deformation in the sub-scanning direction of the image data of the correction pattern, and the correction-value acquiring program measures the darkness of each row region based on the corrected image data of the correction pattern and calculates a correction value corresponding to each row region in accordance with the darkness of each row region. Since the deformation in the sub-scanning direction of the image data of the correction pattern is corrected by the image correction program, the row regions of the image data correspond properly to the row regions of the correction pattern. Therefore, the correction-value acquiring program can properly measure the darkness of the row regions of the correction pattern and calculate the correction values corresponding to the respective row regions.

In the foregoing embodiment, the correction pattern is used for acquiring correction values for correcting the darkness of the row regions. This, however, is not a limitation, and for example, the correction pattern may be used for correcting the carry amount of the carry unit of the printing apparatus.

(11) Further, it goes without saying that the foregoing embodiment discloses methods for manufacturing printers (an example of “printing apparatuses”) provided with a memory for storing the correction values. With such printer manufacturing methods, it is possible to manufacture printers storing correction values corresponding to the characteristics of the individual printers, even when there is an error in the scanner 150.

(12) Needless to say, the foregoing embodiment discloses printing methods as well.

What is claimed is:

1. An image processing method, comprising:
a first reading step of reading, as image data, a scale with a scanner;
a second reading step of reading, as image data, a document with the scanner; and
a correction step of correcting the image data of the document using the image data of the scale.

2. An image processing method according to claim 1, further comprising
a step of detecting a position of a graduation marking on the scale based on the image data of the scale,
wherein, in the correction step, the image data of the document is corrected based on the position of the graduation marking on the scale.

3. An image processing method according to claim 2,
wherein, in the correction step, the image data of the document is corrected by calculating, based on the image data of the document, pixel data corresponding to the position of the graduation marking among a plurality of pieces of pixel data that make up the corrected image data.

4. An image processing method according to claim 3,
wherein, in the correction step, the pixel data corresponding to the position of the graduation marking among the plurality of pieces of the pixel data that make up the corrected image data is calculated based on the image data of the document, by performing linear interpolation with respect to pixel data that make up the image data of the document.

5. An image processing method according to claim 2, further comprising
a step of obtaining a position at a shorter interval than an interval of the graduation marking based on the position of the graduation marking on the scale,
wherein, in the correction step, the image data of the document is corrected based on the position at the shorter interval.

6. An image processing method according to claim 5,
wherein the position at the shorter interval is obtained through linear interpolation based on the position of the graduation marking on the scale.

7. An image processing method according to claim 1,
wherein the scanner has a reading carriage that moves in order to make a sensor for reading an image move; and
wherein, in the first reading step, the scale that is set in a direction in which the reading carriage moves is read.

8. An image processing method according to claim 1,
wherein the document has a pattern formed thereon, the pattern being made up of a plurality of dot rows, each dot row being formed in a row region by ejection of ink from at least one of a plurality of nozzles that move in a movement direction, each row region being arranged in the movement direction of the nozzles, the plurality of dot rows that make up the pattern being respectively formed in a plurality of the row regions that are lined up in a direction intersecting the movement direction; and
wherein a darkness of each of the row regions is measured using image data of the pattern, which is the image data of the document, that has been corrected in the correction step.

9. A correction-value acquiring method, comprising:
reading, as image data, a scale with a scanner;
printing a pattern using a printing apparatus;
reading, as image data, the pattern with the scanner;
correcting the image data of the pattern using the image data of the scale; and
acquiring a correction value that suits the printing apparatus by using the image data of the pattern that has been corrected.

10. A printing method, comprising:
reading, as image data, a scale with a scanner;
printing a pattern using a printing apparatus;
reading, as image data, the pattern with the scanner;
correcting the image data of the pattern using the image data of the scale; and
printing with the printing apparatus, while correcting, by using the image data of the pattern that has been corrected, the printing that is carried out by the printing apparatus.
